(19) United States
(12) Patent Application Publication
(10) Pub. No.: US 2017/0332319 A1
(43) Pub. Date: Nov. 16, 2017

(54) COMMUNICATION DEVICE, COMMUNICATION METHOD, AND PROGRAM

(71) Applicant: NEC CORPORATION, Tokyo (JP)

(72) Inventor: Atsushi FUJIMURA, Tokyo (JP)

(73) Assignee: NEC CORPORATION, Tokyo (JP)

(21) Appl. No.: 15/520,311

(22) PCT Filed: Oct. 9, 2015
(86) PCT No.: PCT/JP2015/078812

§ 371 Date: Apr. 19, 2017

(30) Foreign Application Priority Data
Oct. 20, 2014 (JP) 2014-213456

(51) Int. Cl. H04W 52/02; H04W 40/22; H04W 84/18

(52) U.S. Cl. CPC H04W 52/0203; H04W 40/22; H04W 84/18

(57) ABSTRACT

Provided is a communication device (10) that is a node capable of communication with an external device, the communication device including a first transmission unit (120) that transmits power consumption data of the node and power consumption data acquired from another node to the external device, a second transmission unit (130) that transmits the power consumption data of the node to the other node, and a determination unit (140) that determines which of a process by the first transmission unit (120) and a process by the second transmission unit (130) is to be executed based on a predetermined condition.

### TECHNICAL FIELD

The present invention relates to a communication device, a communication method, and a program.

### BACKGROUND ART

Patent document 1 below discloses a technology of a mesh type ad hoc wireless network including an upper repeater and an ad hoc wireless node having a smart meter functional unit, in which meter reading information collected by an upper repeater is delegated from the upper repeater to each ad hoc wireless node of one hop in order to improve use efficiency of a wireless band near the upper repeater.

Further, Patent Document 2 discloses a technology of a connection system for a portable terminal connecting a mobile terminal of a user to an external communication line via a private base station, in which the mobile terminal and the private base station communicate using a short-range wireless communication system (Bluetooth: registered trademark). The portable terminal includes a communication function using a mobile telephone line, in addition to the communication function using the short-range wireless communication system. Further, the private base station includes a unit that controls to switch communication of the portable terminal in a communication area of the private base station by prohibiting communication through the mobile telephone line and performing communication through the short-range wireless communication system.

Further, Patent Document 3 below discloses a technology of a plurality of NCUs each having a transfer device, in which when an NCU receives a command signal of a meter management entity from an artificial satellite, the NCU automatically transfers the command signal to another peripheral NCU. Further, even in a case where an NCU cannot directly receive the command signal radiated and transmitted from the artificial satellite due to a surrounding environment or the like, the NCU can receive the command signal through automatic transfer from another NCU.

### RELATED DOCUMENT

### Patent Document

[Patent Document 1] Japanese Unexamined Patent Application Publication No. 2013-187615
[Patent Document 2] Japanese Unexamined Patent Application Publication No. 2002-077032
[Patent Document 3] Japanese Unexamined Patent Application Publication No. 2005-006202

### SUMMARY OF THE INVENTION

Since the node functioning as an aggregation device when aggregating data from each node in a network is fixed in any one of the above-described patent documents, there is a possibility that the data from each node could not be transmitted to a central node such as a base station when an abnormality occurs in the node being the aggregation device.

An object of the present invention is to provide a technology for aggregating data from a plurality of nodes in a network and stably transmitting the data to a central node.

According to the present invention, there is provided a communication device that is a node capable of communication with an external device, the communication device including:
a first transmission unit that transmits power consumption data of the node and power consumption data acquired from another node to the external device;
a second transmission unit that transmits the power consumption data of the node to the other node; and
a determination unit that determines which of a process by the first transmission unit and a process by the second transmission unit is executed based on a predetermined condition.

According to the present invention, there is provided a communication method, executed by a computer that is a node capable of communication with an external device, the method including:
a first transmission process of transmitting power consumption data of the node and power consumption data acquired from another node to the external device;
a second transmission process of transmitting the power consumption data of the node to the other node; and
a determination process of determining which of the first transmission process and the second transmission process is to be executed based on a predetermined condition.

According to the present invention, there is provided a program for causing a computer that is a node capable of communication with an external device to function as:
a first transmission unit that transmits power consumption data of the node and power consumption data acquired from another node to the external device;
a second transmission unit that transmits the power consumption data of the node to the other node; and
a determination unit that determines which of a process by the first transmission unit and a process by the second transmission unit is to be executed based on a predetermined condition.

### Advantageous Effects of Invention

According to the present invention, it is possible to aggregate data from a plurality of nodes in a network and stably transmit the data to a central node.

### BRIEF DESCRIPTION OF THE DRAWINGS

The above object and other objects, features, and advantages will become more apparent from preferred exemplary embodiments to be described below and the accompanying drawings below.

FIG. 1 is a diagram illustrating a schematic system configuration using a communication device of the present invention.

FIG. 2 is a block diagram conceptually illustrating a processing configuration of a communication device in a first exemplary embodiment.

FIG. 3 is a diagram conceptually illustrating an example of a hardware configuration of a communication device in the first exemplary embodiment.

FIG. 4 is a flowchart illustrating a flow of a communication device in the first exemplary embodiment acquiring power consumption data of the own node.

FIG. 5 is a flowchart illustrating a flow of determining which of processes of a first transmission unit and a second transmission unit is to be executed by the communication device in the first exemplary embodiment.

FIG. 6 is a flowchart illustrating a flow of a process of a first transmission unit in the first exemplary embodiment.

FIG. 7 is a flowchart illustrating a flow of a process of a second transmission unit in the first exemplary embodiment.

FIG. 8 is a flowchart illustrating a flow of a process of a second transmission unit in a second exemplary embodiment.

FIG. 9 is a block diagram conceptually illustrating a processing configuration of a communication device in a modification example of the second exemplary embodiment.

FIG. 10 is a flowchart illustrating a flow of a process of a first transmission unit in a modification example of the second exemplary embodiment.

FIG. 11 is a flowchart illustrating a flow of a process of a second transmission unit 130 in the modification example of the second exemplary embodiment.

FIG. 12 is a flowchart illustrating a flow of a process of a first transmission unit in another modification example of the second exemplary embodiment.

FIG. 13 is a flowchart illustrating a flow of a process of a second transmission unit 130 in the other modification example of the second exemplary embodiment.

FIG. 14 is a diagram conceptually illustrating a processing configuration of a communication device in a third exemplary embodiment.

FIG. 15 is a flowchart illustrating a flow of determining which of processes of a first transmission unit and a second transmission unit is to be executed by the communication device in the third exemplary embodiment.

FIG. 16 is a block diagram conceptually illustrating a processing configuration of a communication device in a fourth exemplary embodiment.

FIG. 17 is a flowchart illustrating a flow of determining which of processes of a first transmission unit and a second transmission unit is to be executed by the communication device in the fourth exemplary embodiment.

FIG. 18 is a block diagram conceptually illustrating a processing configuration of a communication device in a fifth exemplary embodiment.

FIG. 19 is a flowchart illustrating a flow of determining which of processes of a first transmission unit and a second transmission unit is to be executed by the communication device in the fifth exemplary embodiment.

FIG. 20 is a block diagram conceptually illustrating a processing configuration of a communication device in a sixth exemplary embodiment.

FIG. 21 is a flowchart illustrating a flow for determining which of processes of a first transmission unit and a second transmission unit is to be executed by the communication device in the sixth exemplary embodiment.

FIG. 22 is a diagram conceptually illustrating an example of a processing configuration of a communication device in a seventh exemplary embodiment.

FIG. 23 is a diagram illustrating a network built by a plurality of communication devices.

FIG. 24 is a sequence diagram illustrating a flow in which a plurality of communication devices share reception radio wave intensity.

FIG. 25 is a flowchart illustrating a flow of determining which of processes of a first transmission unit and a second transmission unit is to be executed by the communication device in the seventh exemplary embodiment.

FIG. 26 is a diagram conceptually illustrating an example of a processing configuration of a communication device in an eighth exemplary embodiment.

FIG. 27 is a sequence diagram illustrating a flow in which a plurality of communication devices share the number of communicable nodes.

FIG. 28 is a flowchart illustrating a flow of determining which of processes of a first transmission unit and a second transmission unit is to be executed by the communication device in the eighth exemplary embodiment.

### DESCRIPTION OF EXEMPLARY EMBODIMENTS

Hereinafter, exemplary embodiments of the present invention will be described with reference to the drawings. In all the drawings, the same components are denoted with the same reference numerals, and description thereof will not be repeated.

[System Configuration]

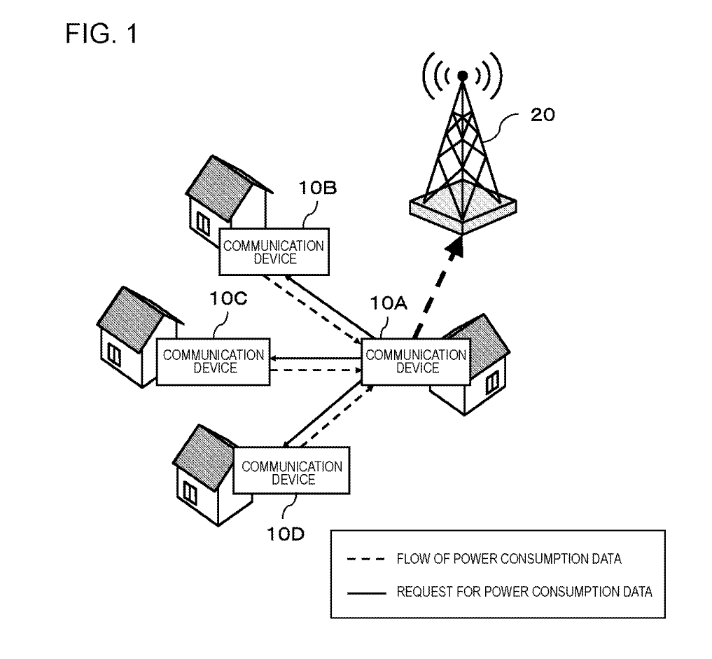

An example of the system configuration in the present invention is illustrated in FIG. 1. FIG. 1 is a diagram illustrating a schematic system configuration using a communication device of the present invention. In the example of FIG. 1, a network is built by a plurality of communication devices 10A to 10D and an external device (for example, a central node 20). In the following description, the communication device 10 is referred to as a “node”. However, the system configuration of the present invention is not limited to the example of FIG. 1. For example, the communication device 10 included in the network may be configured to be capable of communicating with an external device other than the central node.

The plurality of communication devices 10A to 10D acquire power consumption data indicating power consumed by loads different from each other and transmit the power consumption data to the central node 20. An example of the central node includes a server device or a wireless base station, but the present invention is not limited thereto. In the example of FIG. 1, the communication device 10A aggregates the power consumption data acquired by the communication devices 10B to 10D that are adjacent nodes, and transmits the power consumption data to the central node 20. In this case, the communication device 10A may also be referred to as an aggregation device. In the present invention, the communication device 10 serving as an aggregation device can be switched with another communication device based on predetermined conditions. In each of exemplary embodiments described below, details thereof will be described.

### First Exemplary Embodiment

[Processing Configuration]

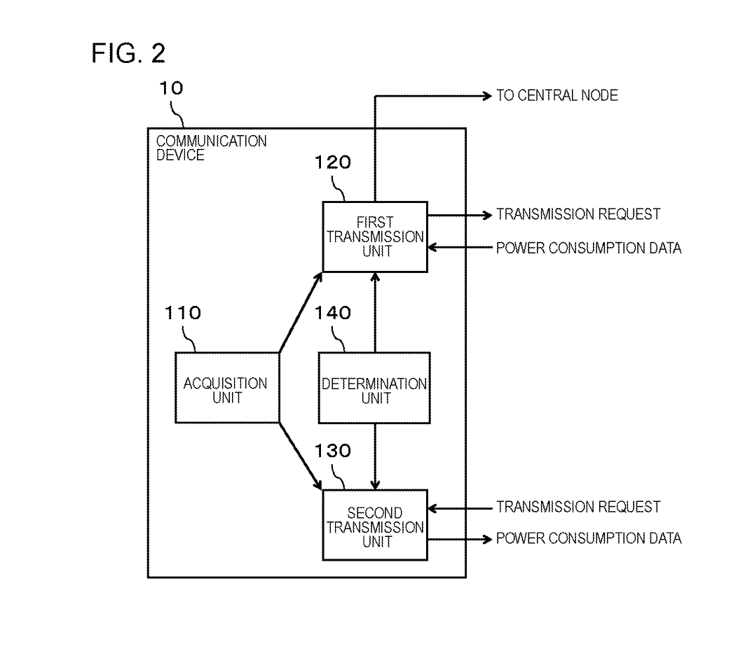

FIG. 2 is a block diagram conceptually illustrating a processing configuration of a communication device 10 in the first exemplary embodiment. As illustrated in FIG. 2, the communication device 10 of this exemplary embodiment includes an acquisition unit 110, a first transmission unit 120, a second transmission unit 130, and a determination unit 140.

The acquisition unit 110 communicates with a watt hour meter and acquires power consumption data of the own node. The acquisition unit 110 acquires the power consumption data of the own node from the watt hour meter at a predetermined timing (acquisition timing).

In the present invention, the watt hour meter is a device capable of measuring, for example, power consumption of a target load of an electronic device or the like and transmitting a result of the measurement to the communication device 10. The so-called “smart meter” is an example of the watt hour meter. Here, the communication device 10 of the present invention may be incorporated in the watt hour meter such as a smart meter, or may be configured to be connectable or communicable with the watt hour meter.

In the present invention, the power consumption data is information including a power accumulation value measured by the watt hour meter in a predetermined period of time (for example, 30 minutes). The power consumption data may further include, for example, time information.

The first transmission unit 120 transmits the power consumption data of the own node acquired by the acquisition unit 110 and power consumption data of another node acquired from another node to the central node 20. For example, the first transmission unit 120 transmits a power consumption data transmission request to the other node to acquire power consumption data of the other node.

In response to the transmission request from the other node, the second transmission unit 130 transmits the power consumption data of the own node acquired by the acquisition unit 110 to the other node. The “power consumption data of the other node” acquired by the first transmission unit 120 described above is transmitted from the second transmission unit 130.

The determination unit 140 determines which of a process by the first transmission unit 120 and a process by the second transmission unit 130 is to be executed based on a predetermined condition. The determination unit 140 issues a process execution instruction to either one of the first transmission unit 120 and the second transmission unit 130 according to a result of the determination.

Here, the “predetermined condition” is a condition for determining whether or not the communication device 10 causes the process by the first transmission unit 120 to be executed (that is, whether or not the communication device 10 functions as an aggregation device), and various conditions can be set. The predetermined condition may include a communication device that is in a state in which power consumption data of the own node can be transmitted. Further, the predetermined condition may include, for example, at least one of conditions such as “the earliest transmission timing of power consumption data of the own node in a predetermined period”, “the best communication status with the central node 20”, and “the largest number of nodes communicable in one hop”. However, the predetermined condition is not limited to these examples.

In the present invention, the first transmission unit 120 and the second transmission unit 130 may be implemented as different hardware or may be implemented as different software installed in the same hardware.

[Hardware Configuration]

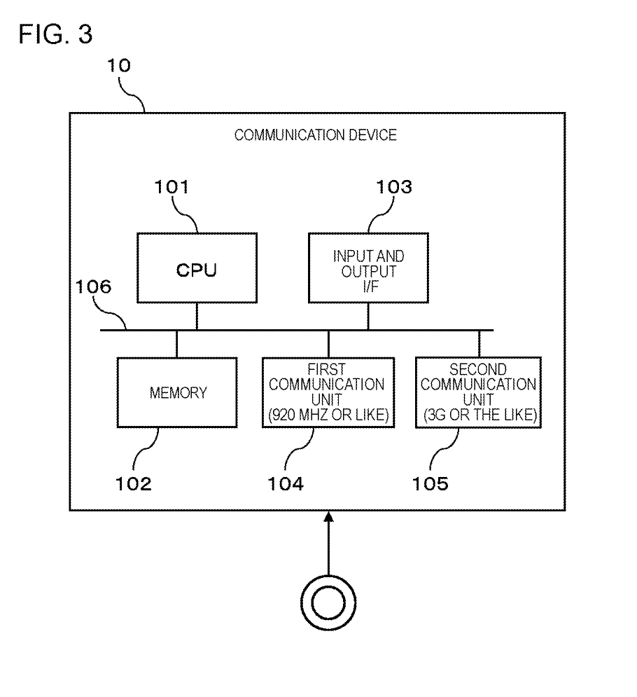

FIG. 3 is a diagram conceptually illustrating a hardware configuration example of the communication device according to the first exemplary embodiment. As illustrated in FIG. 3, the communication device 10 includes a central processing unit (CPU) 101, a memory 102, an input and output interface (I/F) 103, a first communication unit 104, a second communication unit 105, and the like. The CPU 101 is connected to the other units by a communication line such as a bus 106. The memory 102 is a random access memory (RAM), a read only memory (ROM), a flash memory, or the like.

The first communication unit 104 performs communication using a specific low power wireless system that uses a band such as a 920 MHz band. In the first communication unit 104, for example, a Wireless Smart Utility Network (Wi-SUN) can be adopted as a communication system. The Wi-SUN has features of low power consumption, long range, and reduced radio wave interference with another wireless system, as compared to a wireless local area network (LAN) (so-called “Wi-Fi (Wireless Fidelity)”). Further, since the Wi-SUN has superior radio wave diffraction properties, it is possible to ensure stable communication even in a place where there are walls or obstacles. A 920 MHz band system is also preferable in that it has higher communication speed (a maximum of about 200 kbps) than that of other specific low power wireless systems (400 MHz band). Further, the present invention is not limited to this, and the first communication unit 104 may be configured to be capable of communication in a wireless system such as ZigBee (registered commercial law) using a 2.4 Ghz band.

The second communication unit 105 performs communication via a mobile phone communication network that uses a mobile phone communication system adopting 3rd Generation (3G), Long Term Evolution (LTE), or the like.

The first transmission unit 120 performs data transmission using the first communication unit 104 (for example, a 920 MHz specified low power wireless communication module) and the second communication unit 105 (for example, a 3G or LTE communication module). Further, the second transmission unit 130 performs data transmission using the first communication unit 104 (for example, a 920 MHz specific low power wireless communication module).

Further, the acquisition unit 110 acquires the power consumption data from the watt hour meter via the first communication unit 104. Further, in a case where the communication device 10 and the watt hour meter are connected via the input and output I/F 103, the acquisition unit 110 can acquire the power consumption data from the watt hour meter via the input and output I/F 103. For example, the acquisition unit 110 is connected to a wattmeter via a connection unit such as infrared rays or wiring, and the acquisition unit 110 acquires the power consumption data from the wattmeter via the connection unit.

A hardware configuration of the communication device 10 is not limited to the configuration illustrated in FIG. 3. The communication device 10 may further have a configuration other than the configuration illustrated in FIG. 3.

Each processing unit of the communication device 10 described above is implemented, for example, by a program stored in the memory 102 being executed by the CPU 101. The program, for example, is installed from a portable storage medium such as a compact disc (CD) or a memory card via the input and output I/F 103 and stored in the memory 102. Alternatively, the program may be installed from another computer on a network and stored in the memory 102.

### Operation Example

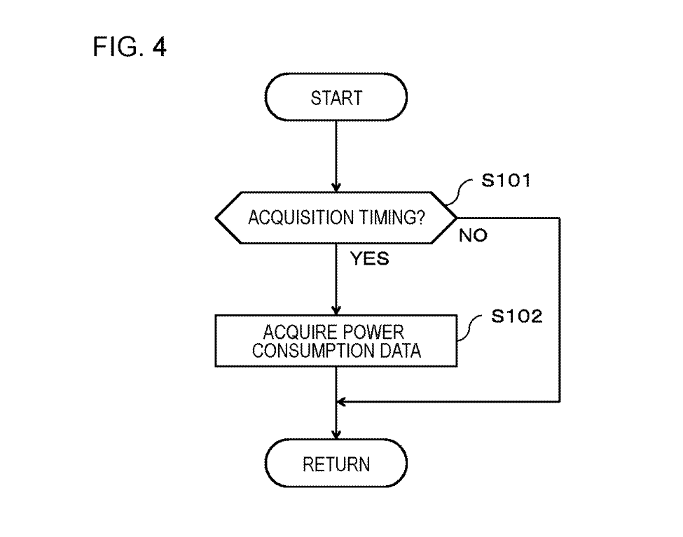

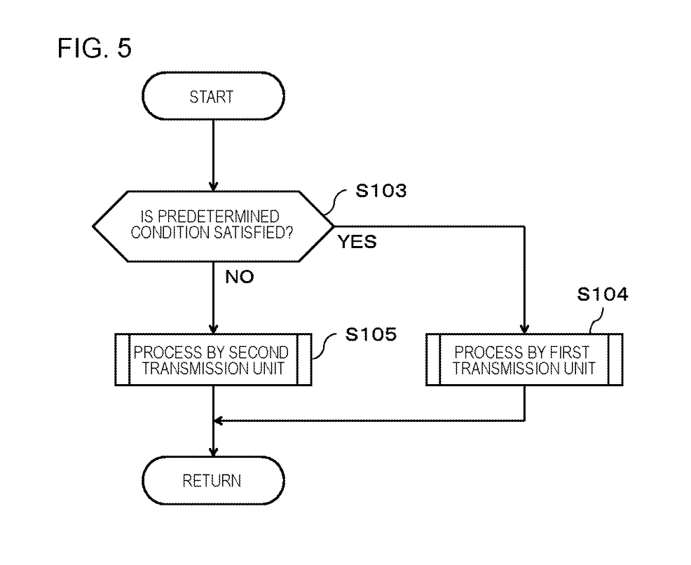

An example of an operation of the communication device 10 in this exemplary embodiment will be described with reference to FIGS. 4 and 5. FIG. 4 is a flowchart illustrating a flow in which the communication device 10 in the first exemplary embodiment acquires the power consumption data of the own node. FIG. 5 is a flowchart illustrating a flow of a determining which of processes of the first transmission unit 120 and the second transmission unit 130 is to be executed by the communication device 10 in the first exemplary embodiment. Respective processes illustrated in FIGS. 4 and 5 are independently executed in parallel.

First, a flow of acquisition of the power consumption data of the own node will be described with reference to FIG. 4.

First, the acquisition unit 110 determines whether or not an acquisition timing of the power consumption data of the own node has arrived (S101). The acquisition timing of the power consumption data is preset in each communication device 10. The acquisition timing of the power consumption data may be the same in all of the plurality of communication devices 10 or may be different in at least some of the communication devices 10. When the timing is not an acquisition timing for power consumption data (S101), the process proceeds to S103 to be described below. On the other hand, when the timing is an acquisition timing for power consumption data (S101: YES), the acquisition unit 110 acquires the power consumption data of the own node from the watt hour meter (S102). In this case, the communication device 10 sets a data flag to “1”. The data flag indicates a transmitted state or a non-transmitted state of the power consumption data. In this example, the data flag “1” indicates a state in which the power consumption data has been acquired but has not yet been transmitted (that is, the communication device is in a transmission waiting state). Further, an initial value of the data flag is “0”, meaning either of a state in which the power consumption data has not yet been acquired and the power consumption data has not been transmitted (that is, the communication device is in an acquisition waiting state) or a state in which the acquired power consumption data has already been transmitted (that is, a transmission completion state). In either of the states, the data flag “0” indicates that there is no power consumption data to be transmitted.

Next, a flow of determining which of processes of the first transmission unit 120 and the second transmission unit 130 is to be executed by the communication device 10 will be described with reference to FIG. 5.

First, the determination unit 140 determines whether or not the predetermined condition as described above is satisfied (S103). In a case where the predetermined condition is satisfied (S103: YES), the determination unit 140 issues a process execution instruction to the first transmission unit 120, and the process is executed by the first transmission unit 120 (S104). On the other hand, in a case where the predetermined condition is not satisfied (S103: NO), the determination unit 140 issues a process execution instruction to the second transmission unit 130, and the process is executed by the second transmission unit 130 (S105). The process by the first transmission unit 120 and the process by the second transmission unit 130 will be described below.

<<Process of First Transmission Unit 120>>

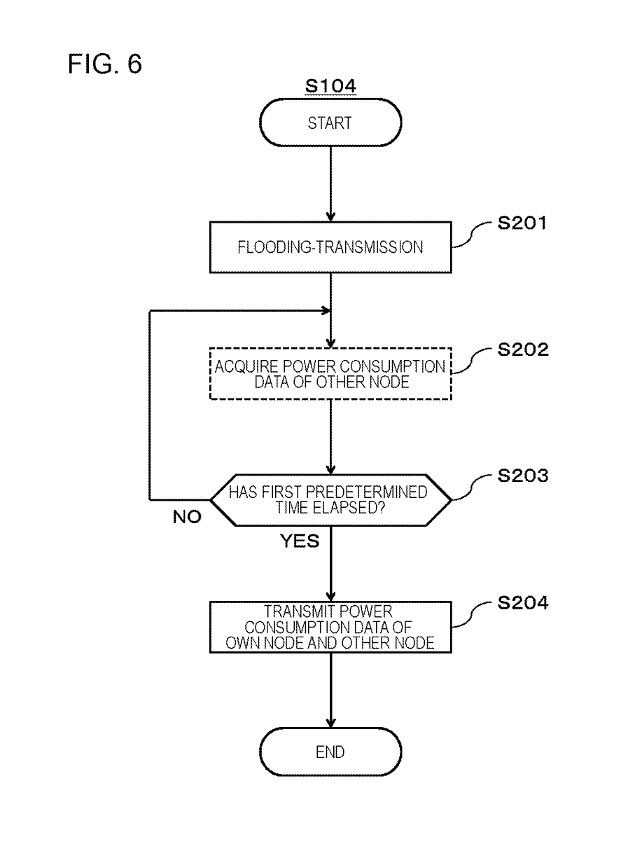

A flow of a process of the first transmission unit 120 will be described with reference to FIG. 6. FIG. 6 is a flowchart illustrating the flow of the process of the first transmission unit 120 in the first exemplary embodiment.

First, the first transmission unit 120 transmits a power consumption data transmission request by flooding to other nodes in the periphery (the request is broadcast to many and unspecified nodes) (S201). In a case where the power consumption data is transmitted from the other nodes in response to the power consumption data transmission request, the first transmission unit 120 acquires the power consumption data (S202). The first transmission unit 120 waits for the arrival of the power consumption data transmitted from the other nodes until elapse of a predetermined period of time (first predetermined period of time) from the data transmission request by flooding (S203: NO). When the first predetermined period of time has elapsed from the data transmission request by flooding (S203: YES), the first transmission unit 120 transmits the power consumption data of the own node acquired in S102 and the power consumption data of the other node acquired in S202 to the central node (S204). At this time, since the power consumption data of the own node has been transmitted, the communication device 10 sets the data flag to “0”. Thereafter, the process returns to S103 and the process is repeated.

In the flowchart of FIG. 6, the first transmission unit 120 may transmit the power consumption data of the own node and the power consumption data acquired from the other node at different timings. For example, in a case where the power consumption data of the own node is already in a transmission waiting state, the first transmission unit 120 first transmits the power consumption data of the own node to the central node 20. Thereafter, each time the first transmission unit 120 acquires power consumption data from another node, the first transmission unit 120 may sequentially transmit the power consumption data from the other node to the central node 20. Considering the object of reduction of power consumption or the like, it is preferable for the power consumption data of the own node and the power consumption data of the other node to be collectively transmitted, as illustrated in the flowchart of FIG. 6.

<<Process of Second Transmission Unit 130>>

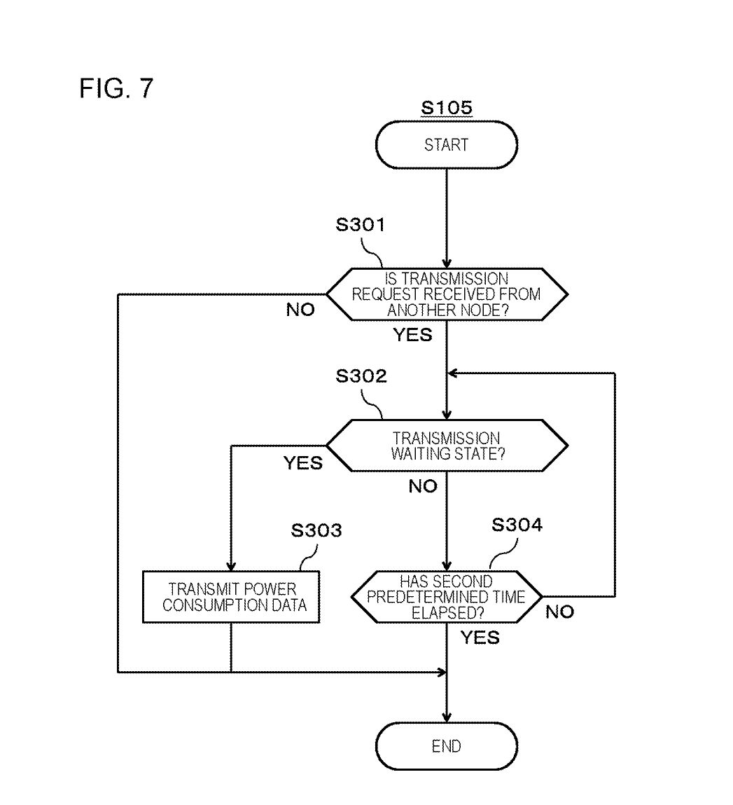

A flow of a process of the second transmission unit 130 will be described with reference to FIG. 7. FIG. 7 is a flowchart illustrating the flow of the process of the second transmission unit 130 in the first exemplary embodiment.

First, the second transmission unit 130 determines whether or not a power consumption data transmission request has been received from another node (S301). In a case where no power consumption transmission request has been received from another node (S301: NO), the process of the second transmission unit 130 ends, and the process returns to S103. On the other hand, in a case where a power consumption data transmission request has been received from another node (S301: YES), the second transmission unit 130 determines whether or not the own node is in the “transmission waiting state” (S302). Here, in a case where the power consumption data of the own node is acquired and the data flag becomes “1”, the own node enters the “transmission waiting state”. In a case where the own node is in the “transmission waiting state”, the second transmission unit 130 transmits the power consumption data acquired in S102 to the other node which is the request source of the transmission request (S303). In this case, since the power consumption data of the own node has been transmitted, the communication device 10 sets the data flag to “0”. On the other hand, in a case where the own node is not in the “transmission waiting state” (S303), the second transmission unit 130 waits for a predetermined period of time (second predetermined period of time) from the reception of the request until the acquisition timing is reached and the own node enters the “transmission waiting state” in the process of FIG. 4 that is executed in parallel (S304: NO). The second predetermined period of time set herein is determined according to the first predetermined period of time in S203 described above. For example, the same first predetermined period of time is preset in each communication device 10, and the second predetermined period of time is set to be somewhat shorter than the first predetermined period of time in consideration of time required for data communication. When the second predetermined period of time has elapsed (S304: YES), the process returns to S103 without the second transmission unit 130 performing any process. In this case, the own node enters the “transmission waiting state” at a later acquisition timing, and the process of the first transmission unit 120 is executed on the predetermined condition being satisfied, or the power consumption data of the own node is transmitted in response to reception of the transmission request from the other node in the process of the second transmission unit 130.

[Operation and Effects of First Exemplary Embodiment]

Thus, in this exemplary embodiment, in a case where the predetermined condition is satisfied in a certain communication device 10, the process by the first transmission unit 120 is executed, and in a case where the predetermined condition is not satisfied, the process by the second transmission unit 130 is executed. In the process executed by the first transmission unit 120, the power consumption data transmission request is transmitted from the communication device 10, and in reply thereto, power consumption data is transmitted from the other communication device 10 to the communication device 10 being the transmission source of the transmission request. In other words, the communication device 10 satisfying the predetermined condition functions as an aggregation device. Further, the communication device 10 functioning as an aggregation device can be dynamically changed according to whether or not the predetermined condition is satisfied. Accordingly, it is possible for any communication device 10 to function as the aggregation device. According to this exemplary embodiment, it is possible to integrate the power consumption data and stably collect the power consumption data into the central node in comparison with use of a method in which the aggregation device is fixed.

Further, in this exemplary embodiment, the communication device 10 functioning as an aggregation device transmits the collected power consumption data to the central node 20. Thus, according to this exemplary embodiment, it is possible to reduce the number of communication devices 10 communicating with the central node 20 in a network in which the central node 20 receives information collected in the plurality of communication devices 10. As a result, it is possible to prevent congestion from occurring due to concentration of access to the central node 20. Further, in general, communication with the central node 20 requires more power than communication with adjacent nodes. Therefore, according to this exemplary embodiment, an effect can be expected of a reduction of power consumption in the entire network.

### Second Exemplary Embodiment

This exemplary embodiment has the same configuration as that of the first exemplary embodiment except for the following points.

[Processing Configuration]

The communication device 10 of this exemplary embodiment has the same processing configuration as the processing configuration of the first exemplary embodiment illustrated in FIG. 2. Further, the second transmission unit 130 of this exemplary embodiment is configured to transfer a transmission request from another node (hereinafter also referred to as an upper node) to still another node (hereinafter also referred to as a lower node) in response to the transmission request from the other (upper) node. In this case, the second transmission unit 130 transmits the power consumption data of the own node acquired by the acquisition unit 110 and the power consumption data acquired from the lower node in response to the transferred transmission request, to the upper node that is the transmission source of the transmission request.

### Operation Example

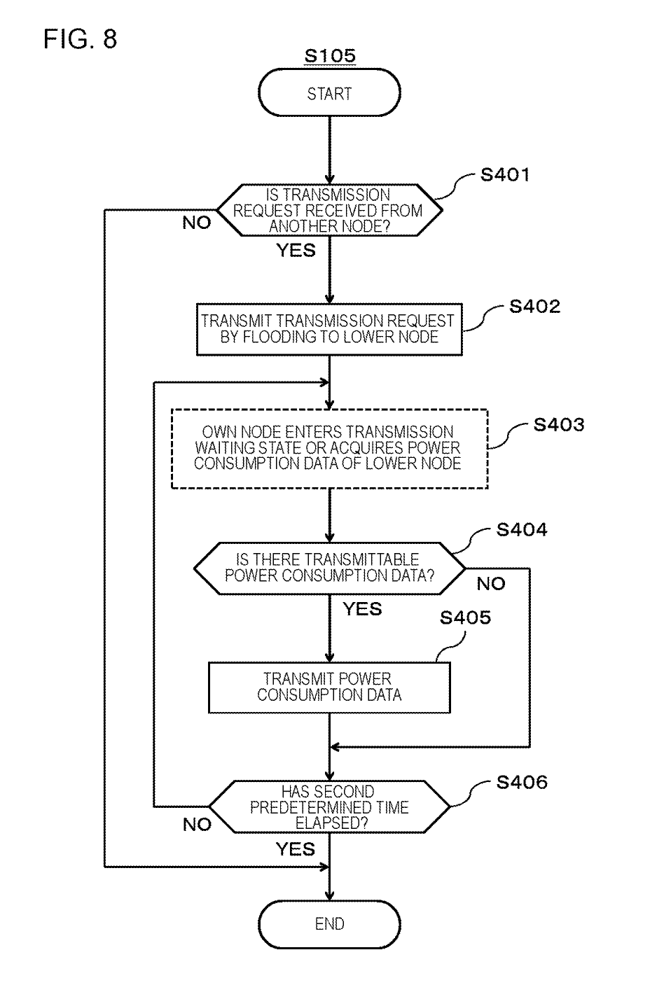

A flow of a process of the communication device 10 of this exemplary embodiment will be described with reference to FIG. 8. FIG. 8 is a flowchart illustrating a flow of a process of the second transmission unit 130 in the second exemplary embodiment.

First, the second transmission unit 130 determines whether or not a power consumption data transmission request has been received from another node (S401). In a case where the power consumption data transmission request has not been received from another node (S401: NO), the process of the second transmission unit 130 ends, and the process returns to S103. The flow is the same as in the first exemplary embodiment up to this point.

On the other hand, in a case where a power consumption data transmission request has been received from another node (S401: YES), the second transmission unit 130 transfers the received transmission request by flooding (S401). Thereafter, in a case where the power consumption data of the own node is acquired in the process of FIG. 4 and the own node enters a “transmission waiting state” or power consumption transmitted from the lower node in response to the transmission request transferred in step S401 is acquired (S403), the communication device enters a state of having power consumption data that can be transmitted. In a case where the communication device has power consumption data that can be transmitted (S404: YES), the second transmission unit 130 sequentially transmits the transmittable consumption data to the upper node (S405). The process of S403 to S405 is repeated until the second predetermined period of time elapses (S406).

[Operation and Effects of Second Exemplary Embodiment]

Accordingly, the communication device 10 functioning as an aggregation device can aggregate the power consumption data in a wider range than in the first exemplary embodiment. As a result, it is possible to enhance an effect of prevention of occurrence of congestion and a power reduction effect in comparison with the first exemplary embodiment.

[One Modification Example of Second Exemplary Embodiment]

According to the second exemplary embodiment, a network is built by a plurality of communication devices 10 (nodes). For example, a multi-hop network is built. In this case, the network is built in a range of the number of hops that is limited by a multi-hop routing protocol or the like, and the transmission request is transferred within this range. However, in a case where a protocol such as a multi-hop network is not used, a case where the transmission request is endlessly transferred is conceivable. If the range of transfer of the transmission request is excessively expanded, the communication device 10 serving as an aggregation device may highly possibly be unable to collect all data. Therefore, in a modification example to be described below, a configuration is added for limiting the range of the network to be supported by an aggregation device to a certain range.

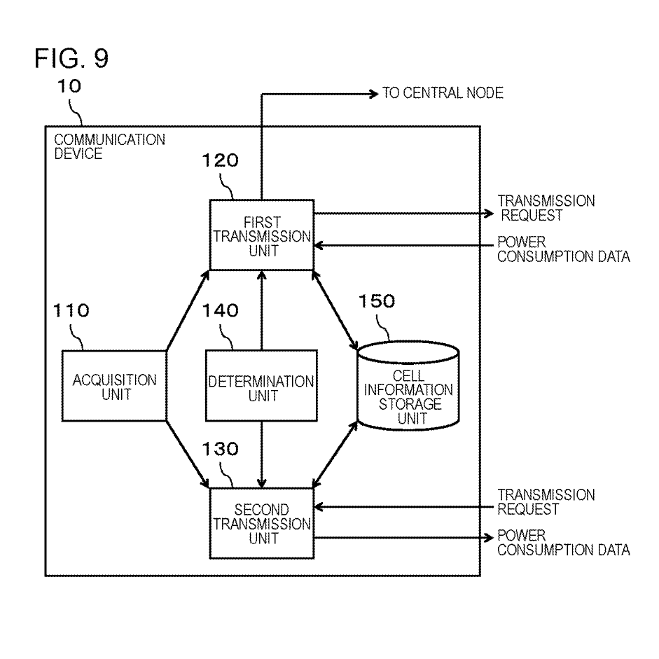

FIG. 9 is a block diagram conceptually illustrating a processing configuration of the communication device 10 according to a modification example of the second exemplary embodiment. In FIG. 9, the communication device 10 further includes a cell information storage unit 150 that stores cell identification information for identifying a cell corresponding to the own node.

The first transmission unit 120 of this modification example attaches the cell identification information stored in the cell information storage unit 150 to a power consumption data transmission request and transmits the request to another node.

The second transmission unit 130 of this modification example determines whether or not the cell identification information attached to the transmission request from the other node (upper node) is the same as the cell identification information of the own node, through comparison with the cell identification information stored in the cell information storage unit 150 of the own node. In a case where the pieces of the cell identification information match each other, the second transmission unit 130 transmits a response to the transmission request from the upper node and also transfers the transmission request to still another node (lower node). On the other hand, if the pieces of the identification information are different from each other, the second transmission unit 130 neither transmits a response to the transmission request from the upper node nor transfers the transmission request to the lower node.

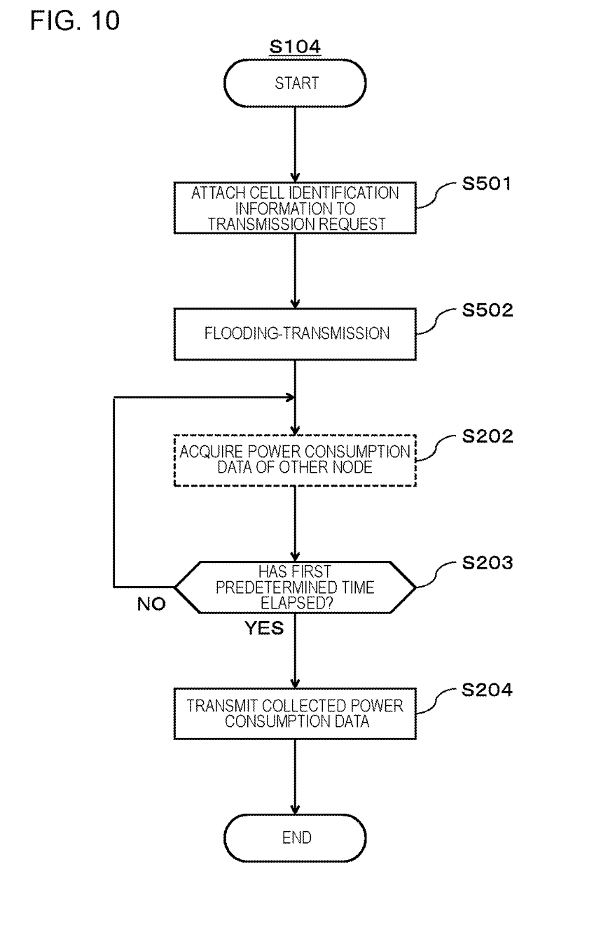

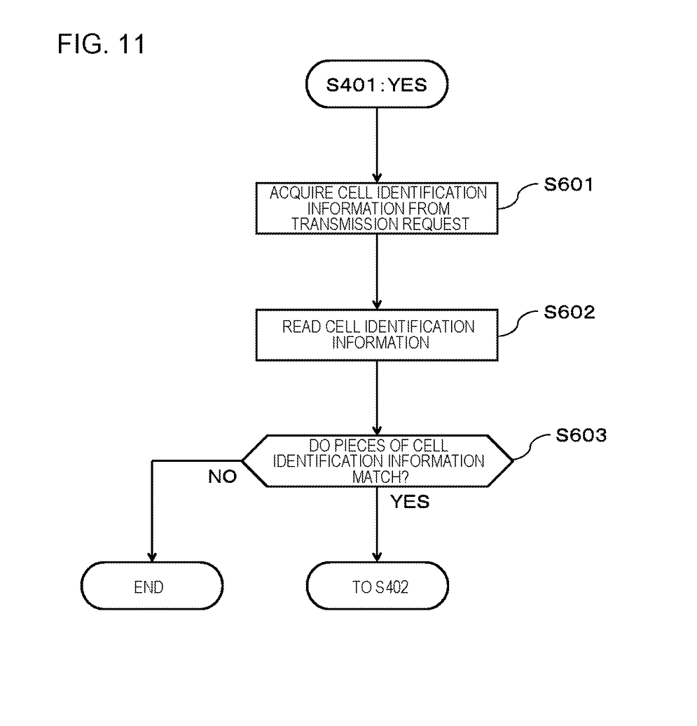

The operation of this modification example will be described with reference to FIGS. 10 and 11. FIG. 10 is a flowchart illustrating a flow of a process of the first transmission unit 120 according to a modification example of the second exemplary embodiment. FIG. 11 is a flowchart illustrating a flow of a process of the second transmission unit 130 according to the modification example of the second exemplary embodiment. Hereinafter, portions (S501, S502, and S601 to S603) different from the process in the second exemplary embodiment will be mainly described.

First, when the first transmission unit 120 transmits the transmission request, the first transmission unit 120 reads the cell identification information from the cell information storage unit 150 and attaches the cell identification information to the transmission request (S501). The first transmission unit 120 transmits the transmission request attached with the cell identification information by flooding (S502).

In a node different from the node that has transmitted the request by flooding, in a case where the transmission request attached with the cell identification information is received (S401: YES), the second transmission unit 130 of the different node acquires the cell identification information attached to the transmission request (S601). Further, the second transmission unit 130 reads the cell identification information stored in the cell information storage unit 150 of the different node (S602). The first transmission unit 120 determines whether or not the cell identification information attached to the transmission request is the same as the cell identification information stored in the cell information storage unit 150 (S603). In a case where the pieces of the cell identification information match each other (S603: YES), the process transitions to S402 for the second transmission unit 130 to continue the process. On the other hand, in a case where the pieces of the cell identification information do not match each other (S603: NO), the second transmission unit 130 ends the process.

By doing so, it is possible to limit the network to be supported by the aggregation device to a range of the cell. Thus, it is possible to prevent the aggregation device from being unable to collect all power consumption data in an over-expanded network and, as a result, to reliably deliver the power consumption data to the central node.

[Another Modification Example of Second Exemplary Embodiment]

Another modification example of the second exemplary embodiment will be described. The modification example further includes a configuration for controlling whether or not to transfer the transmission request according to the number of hops of the network.

Specifically, the first transmission unit 120 of this modification example attaches the hop number information indicating the number of hops of the own node to the transmission request. In a case where the first transmission unit 120 executes its process, the hop number information attached to the transmitted request is “hop number=0” since the own node is the highest node. Further, information indicating the number of hops of the next node may be set in the hop number information. In this case, the hop number information attached to the transmission request that is transmitted from the first transmission unit 120 is “hop number=1”.

The second transmission unit 130 of this modification example determines the number of hops of the own node based on hop number information attached to a transmission request from another node (upper node). For example, in a case where a rule is adopted that the transmission request is to be attached with the number of hops related to the node as a transmission source of the transmission request, the second transmission unit 130 can determine the number of hops of the own node by adding 1 to the number of hops attached to the transmission request. Further, in a case where a rule is adopted that the transmission request is to be attached with the number of hops related to the next node after the node as the transmission source of the transmission request, the second transmission unit 130 can determine the number of hops assigned to the transmission request as the number of hops of the own node. The second transmission unit 130 determines whether or not the determined number of hops of the own node is smaller than a predetermined number of hops. The predetermined number of hops can be set or changed to an appropriate value and set in each node in advance. In a case where the number of hops of the own node is smaller than the predetermined number of hops, the second transmission unit 130 updates the hop number information based on the number of hops of the own node, attaches the updated hop number information, and transfers the transmission request received from the upper node to still another node (lower node). On the other hand, in a case where the number of hops of the own node is equal to or larger than the predetermined number of hops, the second transmission unit 130 does not transfer the transmission request from the upper node to the lower node, and the process transitions to S403. In this case, only the power consumption data of the own node is transmitted to the upper node.

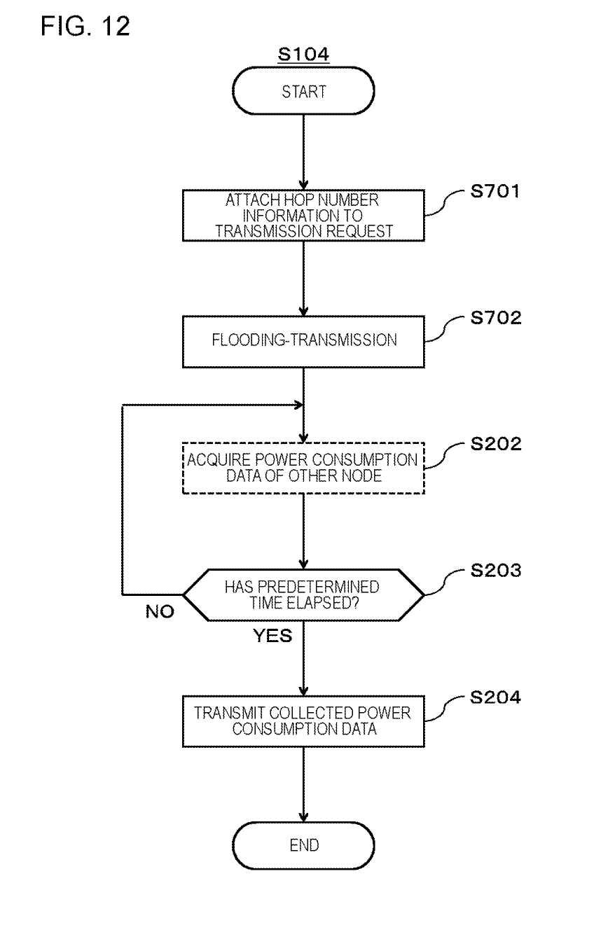

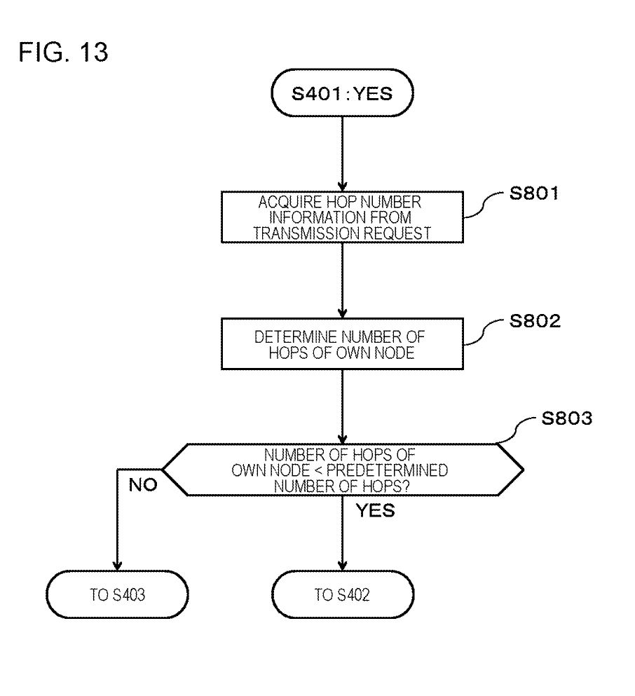

An operation of this modification example will be described with reference to FIGS. 12 and 13. FIG. 12 is a flowchart illustrating a flow of a process of the first transmission unit 120 in another modification example of the second exemplary embodiment. FIG. 13 is a flowchart illustrating a flow of a process of the second transmission unit 130 in another modification example of the second exemplary embodiment. Hereinafter, portions (S701, S702, and S801 to S803) different from the process in the second exemplary embodiment will be mainly described.

First, when the first transmission unit 120 transmits a transmission request, the first transmission unit 120 attaches the hop number information to the transmission request according to the above-described rule (S701). The first transmission unit 120 transmits the transmission request attached with the hop number information by flooding (S702).

When the transmission request attached with the hop number information is received in a different node (S401: YES), the second transmission unit 130 of the different node acquires the hop number information attached to the transmission request (S801). Further, the second transmission unit 130 determines the number of hops of the own node based on the acquired hop number information (S802). The first transmission unit 120 determines whether or not the number of hops of the own node is smaller than a predetermined number of hops (S803). If the number of hops of the own node is smaller than the predetermined number of hops (S603: YES), the process transitions to S402 for the second transmission unit 130 to continue the process. On the other hand, if the number of hops of the own node is equal to or larger than the predetermined number of hops (S603: NO), the second transmission unit 130 ends the process.

By doing so, since the network is built in a range of a predetermined number of hops, it is possible to prevent endless expansion of the range to nodes belonging to other cells.

### Third Exemplary Embodiment

This exemplary embodiment has the same configuration as that of the first exemplary embodiment and the second exemplary embodiment except for the following points. The following description is based on the configuration of the second exemplary embodiment. Further, a case in which “the earliest transmission timing for power consumption data of the own node in a predetermined period” is used for the “predetermined condition” in the first exemplary embodiment will be illustrated in the third exemplary embodiment.

[Processing Configuration]

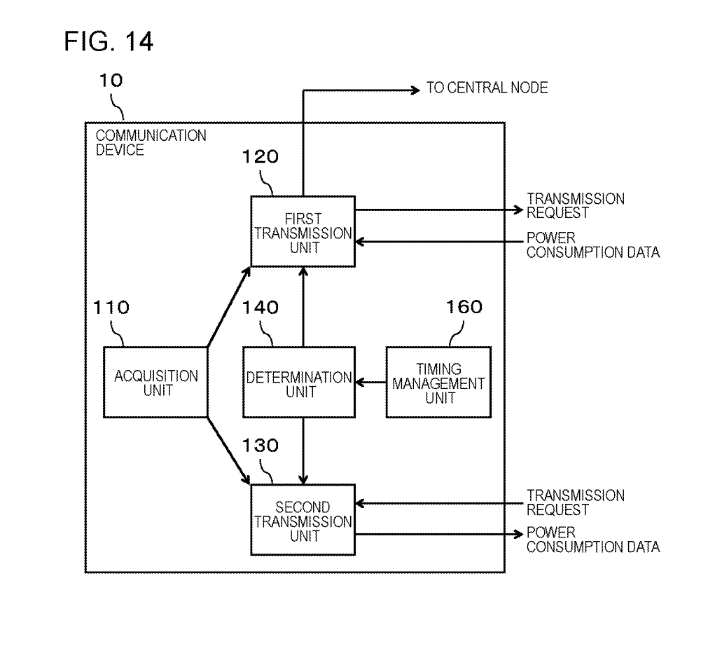

FIG. 14 is a diagram conceptually illustrating a processing configuration of the communication device 10 in the third exemplary embodiment. As illustrated in FIG. 14, the communication device 10 of this exemplary embodiment further includes a timing management unit 160.

The timing management unit 160 manages a timing (transmission timing) at which the power consumption data of the own node is transmitted to the central node 20. In this exemplary embodiment, each node basically executes the process by the first transmission unit 120 when the transmission timing is reached. In this exemplary embodiment, the transmission timings are set as timings that are different in at least some of the nodes. Further, an interval between transmission timings may be the same in all nodes, or may be different in at least some of the nodes.

In a case where the determination unit 140 of this exemplary embodiment receives a transmission request from another node during a period from acquisition of the power consumption data of the own node by the acquisition unit 110 to a transmission timing, the second transmission unit executes its process. In other words, in a case where the determination unit 140 of this exemplary embodiment has not received any transmission request from another node during the period from acquisition of the power consumption data of the own node by the acquisition unit 110 to the data transmission timing, the determination unit 140 causes the first transmission unit 120 to execute its process without causing the second transmission unit 130 to execute its process. Here, each node executes the process by the first transmission unit 120 at the transmission timing, that is, each node transmits the transmission request to another node. Therefore, in other words, the case where “no transmission request from another node has been received during the period from acquisition of the power consumption data of the own node to the transmission timing” means that the own node has the earliest transmission timing in a predetermined unit period of time.

### Operation Example

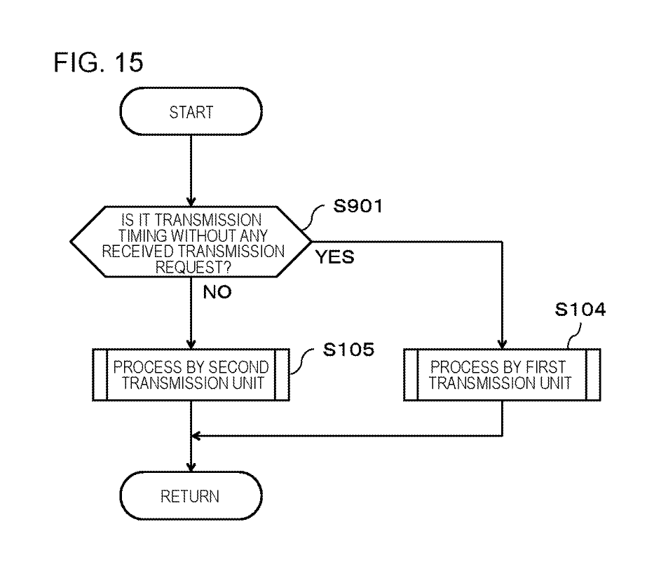

A flow of a process of this exemplary embodiment will be described with reference to FIG. 15. FIG. 15 is a flowchart illustrating a flow for determining which of processes of the first transmission unit 120 and the second transmission unit 130 is to be executed by the communication device 10 in the third exemplary embodiment.

In this exemplary embodiment, the determination unit 140 determines whether or not the transmission timing that is managed by the timing management unit 160 is reached in a state where no transmission request has been received from another node (S901). In a case where both conditions are satisfied (S901: YES), the determination unit 140 issues a process execution instruction to the first transmission unit 120, and the first transmission unit 120 executes its process (S104). On the other hand, in a case where at least any one of the conditions is not satisfied (S901: NO), the determination unit 140 issues a process execution instruction to the second transmission unit 130, and the second transmission unit 130 executes its process (S105).

[Operation and Effects of Third Exemplary Embodiment]

Thus, in this exemplary embodiment, the communication device 10 with the earliest transmission timing in a predetermined unit period of time serves as an aggregation device. Here, the communication device 10 functioning as the aggregation device may be unable to transmit the transmission request at the next transmission timing for some reason such as device failure or bad communication conditions. In such a case, in this exemplary embodiment, the communication device 10 with the second earliest transmission timing satisfies the condition of S901 and functions as the aggregation device. Accordingly, it is possible to dynamically change the communication device 10 serving as the aggregation device in the network and to stably transmit the power consumption data collected from the plurality of communication devices 10 to the central node 20.

### Fourth Exemplary Embodiment

This exemplary embodiment has the same configuration as the third exemplary embodiment except for the following points.

[Processing Configuration]

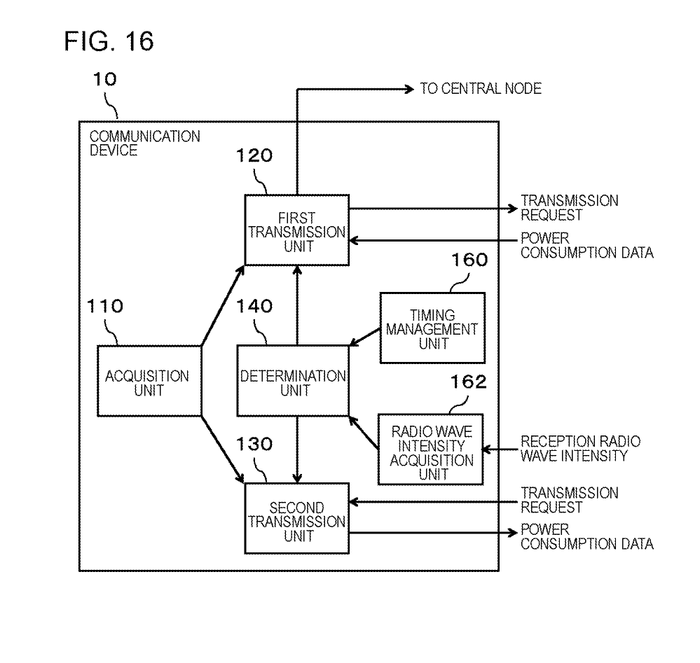

FIG. 16 is a block diagram conceptually illustrating a processing configuration of the communication device 10 in the fourth exemplary embodiment. As illustrated in FIG. 16, the communication device 10 of this exemplary embodiment further includes a radio wave intensity acquisition unit 162, in addition to the configuration of the third exemplary embodiment.

The radio wave intensity acquisition unit 162 monitors radio waves from the central node, and acquires the intensity of the radio waves received in the communication device 10 (hereinafter, reception radio wave intensity). The radio wave intensity acquisition unit 162 acquires the reception radio wave intensity constantly or at predetermined intervals, and notifies the determination unit 140 of the reception radio wave intensity.

In a case where the reception radio wave intensity of the own node is equal to or greater than a predetermined threshold value, the determination unit 140 of this exemplary embodiment causes the first transmission unit 120 to execute its process. In other words, in a case where the reception radio wave intensity of the own node is smaller than the predetermined threshold value, the determination unit 140 of this exemplary embodiment does not cause the first transmission unit 120 to execute its process even when the condition (S901) in the third exemplary embodiment is satisfied.

### Operation Example

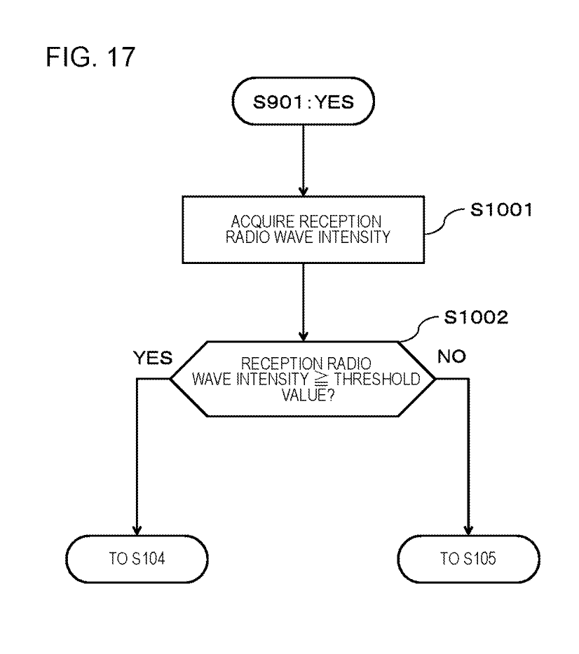

A flow of the process of this exemplary embodiment will be described with reference to FIG. 17. FIG. 17 is a flowchart illustrating a flow for determining which of processes of the first transmission unit 120 and the second transmission unit 130 is to be executed by the communication device 10 in the fourth exemplary embodiment. A process to be described below is performed after the determination of S901 becomes “YES”.

The determination unit 140 acquires the reception radio wave intensity via the radio wave intensity acquisition unit 162 (S1001). Then, the determination unit 140 determines whether or not the acquired reception radio wave intensity is equal to or greater than a predetermined threshold value (S1002). The “predetermined threshold value regarding the reception radio wave intensity” is preset in, for example, the determination unit 140. In a case where the acquired reception radio wave intensity is equal to or greater than the predetermined threshold value (S1002: YES), the determination unit 140 issues a process execution instruction to the first transmission unit 120, and the first transmission unit 120 executes its process (S104). On the other hand, in a case where the acquired reception radio wave intensity is smaller than the predetermined (S1002: NO), the determination unit 140 issues a process execution instruction to the second transmission unit 130, and the second transmission unit 130 executes its process (S105).

[Operation and Effects of Fourth Exemplary Embodiment]

Thus, in this exemplary embodiment, the communication device 10 satisfying the condition of “reception radio wave intensity equal to or greater than a predetermined threshold value” in addition to the condition of “the earliest transmission timing” functions as an aggregation device. Further, the predetermined threshold value is set to a value indicating quality of a certain level or higher. Here, a high radio wave intensity received from the central node 20 may also indicate a good communication environment for transmitting to the central node 20. That is, according to this exemplary embodiment, the communication device 10 having a good communication environment with the central node 20 can be selected as an aggregation device. Further, according to this exemplary embodiment, in a case where a radio wave environment with the central node 20 is bad (radio wave intensity is less than a certain value) even when the transmission timing of the communication device 10 is early, the communication device 10 does not function as an aggregation device. Accordingly, it is possible to accurately allow the communication device 10 having stable communication with the central node to function as the aggregation device, thus improving reliability in transmission of the power consumption data collected in the communication device 10 to the central node 20.

### Fifth Exemplary Embodiment

This exemplary embodiment has the same configuration as that of the first exemplary embodiment except for the following points.

[Processing Configuration]

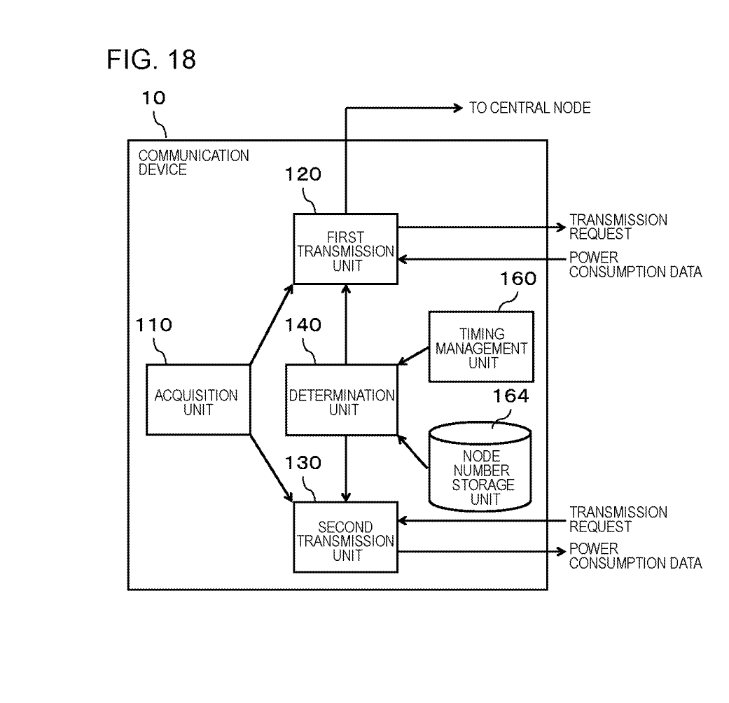

FIG. 18 is a block diagram conceptually illustrating a processing configuration of the communication device 10 according to a fifth exemplary embodiment. As illustrated in FIG. 18, the communication device 10 of this exemplary embodiment further includes a node number storage unit 164, in addition to the configuration of the third exemplary embodiment.

The node number storage unit 164 stores the number of other nodes that can be communicated with in one hop from the own node. The “number of other nodes that can be communicated with in one hop” is set in the node number storage unit 164 in advance based on a prior experimental result or the like. Further, the node number storage unit 164 may update and manage, for example, the number of responses received from other nodes while functioning as an aggregation device, as the “number of other nodes that can be communicated with in one hop”.

The determination unit 140 of this exemplary embodiment causes the first transmission unit 120 to execute its process in a case where the number of other nodes that can be communicated with in one hop from the own node is equal to or greater than a predetermined threshold value by referring to the node number storage unit 164. In other words, the determination unit 140 of this exemplary embodiment does not cause the first transmission unit 120 to execute its process in a case where the number of other nodes that can be communicated with in one hop from the own node is smaller than the predetermined threshold value by referring to the node number storage unit 164.

### Operation Example

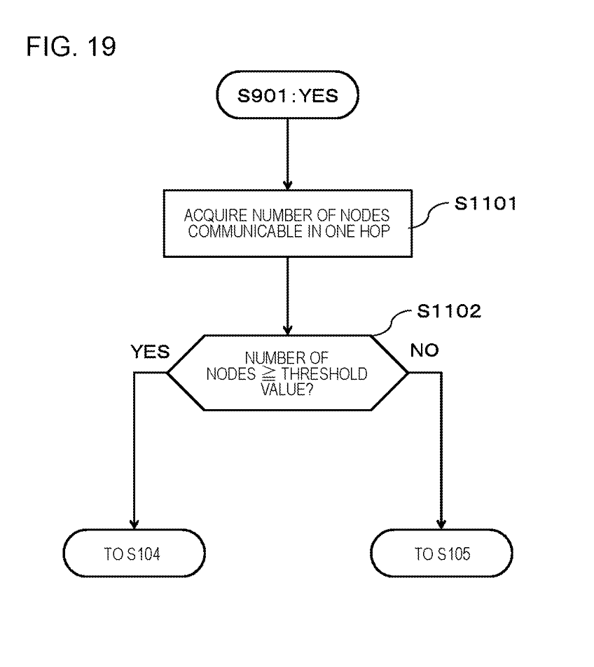

An example of an operation of the communication device 10 in this exemplary embodiment will be described with reference to FIG. 19. FIG. 19 is a flowchart illustrating a flow for determining which of processes of the first transmission unit 120 and the second transmission unit 130 is to be executed by the communication device 10 in the fifth exemplary embodiment. A process to be described below is performed after the determination of S901 becomes “YES”.

The determination unit 140 acquires the number of nodes that can be communicated with in one hop from the own node by referring to the node number storage unit 164 (S1101). Then, the determination unit 140 determines whether or not the acquired number of nodes is equal to or greater than a predetermined threshold value (S1102). The “predetermined threshold value regarding the number of nodes” is preset in, for example, the determination unit 140. In a case where the acquired number of nodes is equal to or greater than the predetermined threshold value (S1102: YES), the determination unit 140 issues a process execution instruction to the first transmission unit 120, and the first transmission unit 120 executes its process (S104). On the other hand, in a case where the acquired number of nodes is smaller than the predetermined (S1102: NO), the determination unit 140 issues a process execution instruction to the second transmission unit 130, and the second transmission unit 130 executes its process (S105).

[Operation and Effects of Fourth Exemplary Embodiment]

Thus, in this exemplary embodiment, the communication device 10 satisfying the condition of “the number of communicable nodes in one hop being equal to or greater than a predetermined threshold value” in addition to the condition of having “the earliest transmission timing” functions as the aggregation device. The communication device having the number of nodes that can be communicated with in one hop that is equal to or greater than a predetermined threshold value is suitable as an aggregation device since the communication device is capable of communicating with a large number of nodes (communication devices 10) in a small number of hops. Thus, according to this exemplary embodiment, the communication device 10 capable of transmitting the transmission request to a certain number of or more nodes can be selected as the aggregation device, and an effect of reducing the time for collecting the power consumption data from each node can be expected.

### Sixth Exemplary Embodiment

A communication device 10 of this exemplary embodiment has a configuration in which the fourth exemplary embodiment and the fifth exemplary embodiment are combined.

[Processing Configuration]

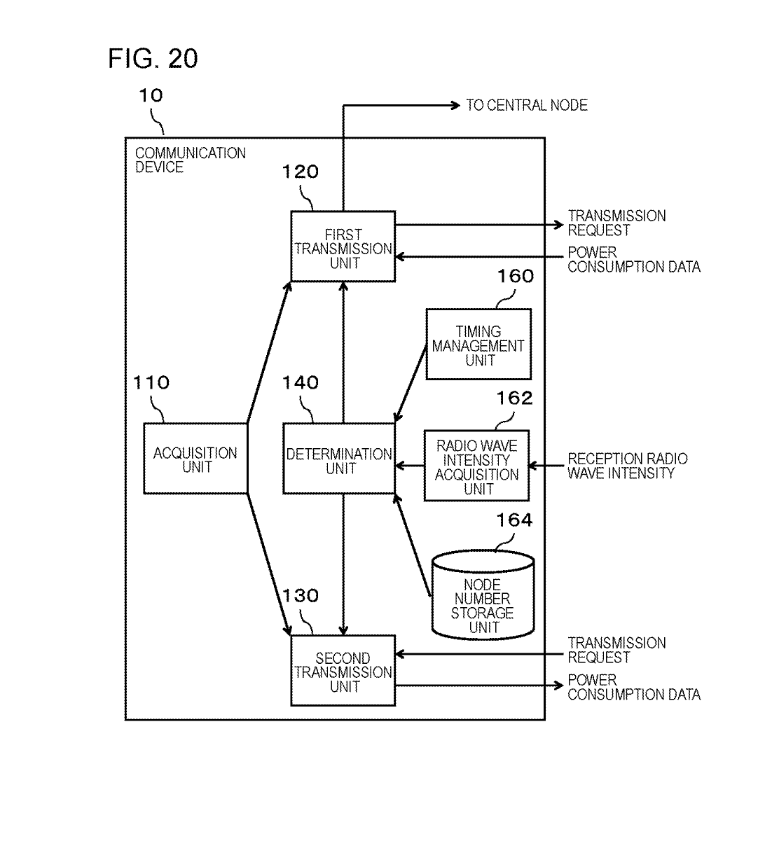

FIG. 20 is a block diagram conceptually illustrating a processing configuration of the communication device 10 in the sixth exemplary embodiment. As illustrated in FIG. 20, the communication device 10 of this exemplary embodiment further includes a radio wave intensity acquisition unit 162 and a node number storage unit 164, in addition to the configuration of the third exemplary embodiment. The radio wave intensity acquisition unit 162 and the node number storage unit 164 perform the same processes as the fourth exemplary embodiment and the fifth exemplary embodiment, respectively.

The determination unit 140 of this exemplary embodiment causes the first transmission unit 120 to execute its process in a case where the reception radio wave intensity of the own node is equal to or greater than a predetermined threshold value. The determination unit 140 of this exemplary embodiment causes the first transmission unit 120 to execute its process in a case where the number of other nodes that can be communicated with in one hop from the own node is equal to or smaller than the predetermined threshold value by referring to the node number storage unit 164. In other words, the determination unit 140 of this exemplary embodiment does not cause the first transmission unit 120 to execute its process in a case where the reception radio wave intensity is smaller than the predetermined threshold value or in a case where the number of other nodes that can be communicated with in one hop from the own node is smaller than the predetermined threshold value. The determination unit 140 of this exemplary embodiment issues a process execution instruction to be executed by the first transmission unit 120 in a case where both of a condition regarding the reception radio wave intensity and a condition regarding the number of nodes that can be communicated with in one hop are satisfied.

### Operation Example

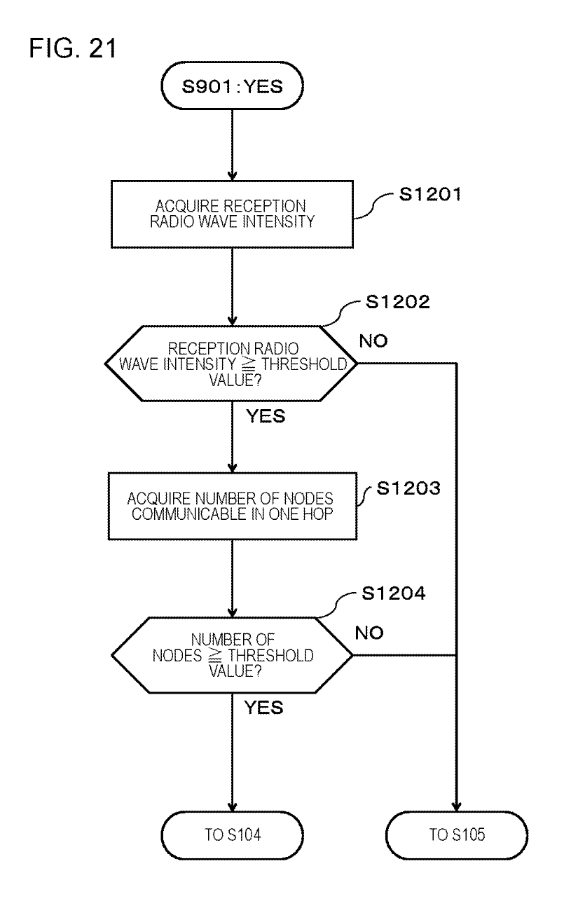

An example of an operation of the communication device 10 in this exemplary embodiment will be described with reference to FIG. 21. FIG. 21 is a flowchart illustrating a flow for determining which of processes of the first transmission unit 120 and the second transmission unit 130 is to be executed by the communication device 10 in the sixth exemplary embodiment. A process to be described below is performed after the determination of S901 becomes “YES”.

The determination unit 140 acquires the reception radio wave intensity via the radio wave intensity acquisition unit 162 (S1201). Then, the determination unit 140 determines whether or not the acquired reception radio wave intensity is equal to or greater than a predetermined threshold value (S1202). The “predetermined threshold value regarding the reception radio wave intensity” is preset in, for example, the determination unit 140. In a case where the acquired reception radio wave intensity is smaller than the predetermined (S1202: NO), the determination unit 140 issues a process execution instruction to the second transmission unit 130, and the second transmission unit 130 executes its process (S105). On the other hand, in a case where the acquired reception radio wave intensity is equal to or greater than the predetermined threshold value (S1202: YES), the determination unit 140 acquires the number of nodes that can be communicated with in one hop from the own node by referring to the node number storage unit 164 (S1203). Then, the determination unit 140 determines whether or not the acquired number of nodes is equal to or greater than a predetermined threshold value (S1204). The “predetermined threshold value regarding the number of nodes” is preset in, for example, the determination unit 140. In a case where the acquired number of nodes is smaller than the predetermined (S1204: NO), the determination unit 140 issues a process execution instruction to the second transmission unit 130, and the process is executed by the second transmission unit 130 (S105). On the other hand, in a case where the acquired number of nodes is equal to or greater than the predetermined threshold value (S1204: YES), the determination unit 140 issues a process execution instruction to the first transmission unit 120, and the process is executed by the first transmission unit 120 (S104).

[Operation and Effects of Sixth Exemplary Embodiment]

Thus, in this exemplary embodiment, the communication device 10 satisfying the conditions of “the reception radio wave intensity of equal to or greater than a predetermined threshold value” and “the number of communicable nodes in one hop of equal to or greater than the predetermined threshold value”, in addition to the condition of having “the earliest transmission timing” functions as the aggregation device. Thus, according to this exemplary embodiment, it is possible to obtain the effects of both of the fourth exemplary embodiment and fifth exemplary embodiment.

### Seventh Exemplary Embodiment

This exemplary embodiment has the same configuration as that of the first exemplary embodiment and the second exemplary embodiment except for the following points. The following description is based on the configuration of the second exemplary embodiment. Further, a case in which a condition of “the best communication condition with the central node 20” is used for the “predetermined condition” in the first exemplary embodiment will be illustrated in the seventh exemplary embodiment.

The determination unit 140 of this exemplary embodiment determines which of the process by the first transmission unit 120 and the process by the second transmission unit 130 is to be executed based on reception radio wave intensity of the own node and that of the other node, the reception radio wave intensity indicating the intensity of radio waves received from the central node.

[Processing Configuration]

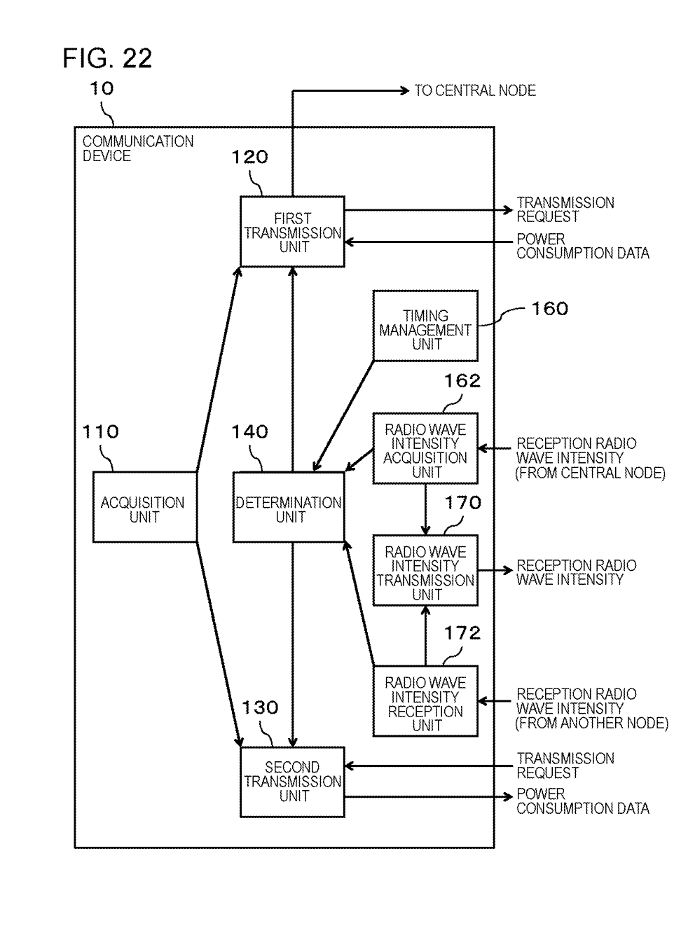

FIG. 22 is a diagram conceptually illustrating an example of a processing configuration of the communication device 10 according to the seventh exemplary embodiment. As illustrated in FIG. 22, the communication device 10 of this exemplary embodiment further includes a timing management unit 160, a radio wave intensity acquisition unit 162, a radio wave intensity transmission unit 170, and a radio wave intensity reception unit 172.

Since the timing management unit 160 is the same as that described in the third exemplary embodiment, description thereof will not be repeated. Further, since the radio wave intensity acquisition unit 162 is the same as that described in the fourth exemplary embodiment, description thereof will not be repeated.

The radio wave intensity transmission unit 170 transmits node identification information for identifying each node along with the reception radio wave intensity of the own node to another node. Further, the radio wave intensity reception unit 172 receives the reception radio wave intensity transmitted from the radio wave intensity transmission unit 170 of the other node. Each communication device 10 can acquire the reception radio wave intensity of each communication device 10 based on the reception radio wave intensity and the node identification information.

Further, the respective communication devices 10 include the radio wave intensity transmission unit 170 and the radio wave intensity reception unit 172, such that in the network built by the plurality of communication devices 10 as illustrated in FIG. 1, the reception radio wave intensities of the respective communication devices 10 can be shared.

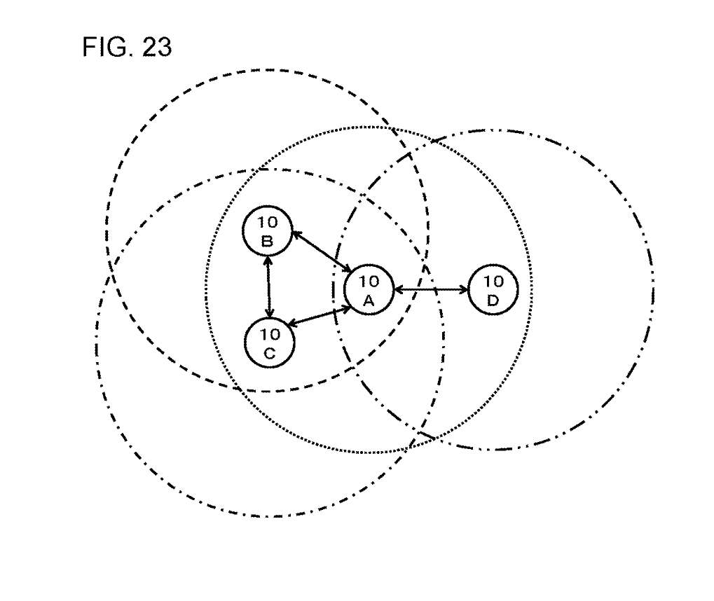

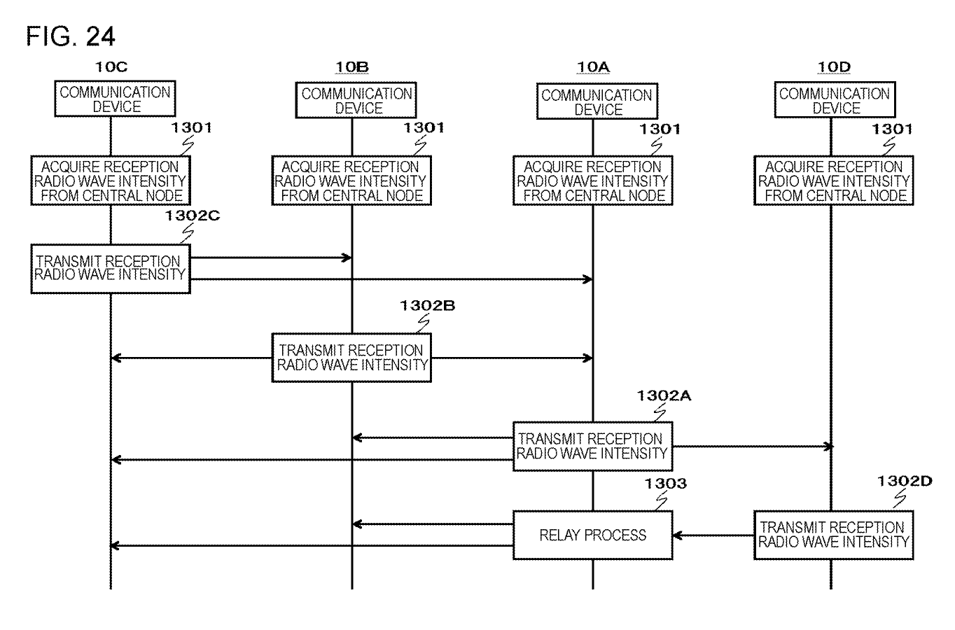

A flow for sharing the reception radio wave intensities of the respective communication devices 10 will be described with reference to FIGS. 23 and 24. FIG. 23 is a diagram illustrating a network built by a plurality of communication devices 10. FIG. 24 is a sequence diagram illustrating a flow of a plurality of communication devices 10 sharing the reception radio wave intensities.

In FIG. 23, a circle around each communication device 10 indicates a communicable range of the first communication unit 104 of each communication device 10, and the arrows indicate communicability among the communication devices 10. In the example of FIG. 24, the communication device 10A is provided at a position to be communicable with the communication devices 10B, 10C, and 10D. Further, the communication device 10B is provided at a position to be communicable with the communication devices 10A and 10C, and the communication device 10C is provided at a position to be communicable with the communication devices 10A and 10B. Further, the communication device 10D is provided at a position to be communicable with the communication device 10A.

A flow of each communication device 10 sharing the reception radio wave intensity will be described with reference to FIG. 24.

First, the radio wave intensity acquisition unit 162 of each of the communication devices 10A to 10D acquires the reception radio wave intensity from the central node 20 (S1301). The radio wave intensity transmission unit 170 of each of the communication devices 10A to 10D attaches, to the acquired reception radio wave intensity, the node identification information of the own node and version information allowing determination of whether the reception radio wave intensity is old or new, for example, and transmits the resultant acquired reception radio wave intensity to another node via the first communication unit 104.

Here, information (reception radio wave intensity information) including the reception radio wave intensity transmitted from each communication device 10 is transmitted to the other communication devices 10 that exist in the communicable range of the first communication unit 104. Specifically, the reception radio wave intensity information of the communication device 10A is transmitted to the communication devices 10B, 10C, and 10D (51302A). Further, the reception radio wave intensity information of the communication device 10B is transmitted to the communication devices 10A and 10C (51302B). Further, the reception radio wave intensity information of the communication device 10C is transmitted to the communication devices 10A and 10B (51302C). Further, the reception radio wave intensity information of the communication device 10D is transmitted to the communication device 10A (51302D).

Here, the radio wave intensity transmission unit 170 of the communication device 10A transmits the reception radio wave intensity information from the communication device 10D to the communication devices 10B and 10C (S1303: relay process). In actuality, the radio wave intensity transmission unit 170 of each communication device 10 transmits, in response to receiving the reception radio wave intensity information from the other communication device 10, the reception radio wave intensity information received from the other communication device 10 to still another communication device 10. Here, a case in which in each communication device 10, the reception radio wave intensity information regarding a certain communication device 10 is relayed from a plurality of communication devices 10 is conceivable. In this case, the communication device 10 having acquired the plurality of pieces of reception radio wave intensity information regarding a certain communication device 10 may determine whether or not the plurality of pieces of the relayed reception radio wave intensity information match each other based on the version information attached to each piece of the reception radio wave intensity information. By doing so, the communication device 10 can always acquire the latest reception radio wave altitude information (highly accurate reception radio wave intensity information).

As described above, it is possible to share the reception radio wave intensity among each of the communication devices 10. However, a method of sharing the reception radio wave intensity is not limited to the above-described examples.

In the configuration of FIG. 22, the determination unit 140 compares the reception radio wave intensity of the own node with that of another node based on the shared information. In a case where the reception radio wave intensity of the own node is the highest as a result of the comparison, the determination unit 140 issues a process execution instruction to the first transmission unit 120. Further, in a case where there is a node having a higher reception radio wave intensity than that of the own node as a result of the comparison, the determination unit 140 issues a process execution instruction to the second transmission unit 130.

### Operation Example

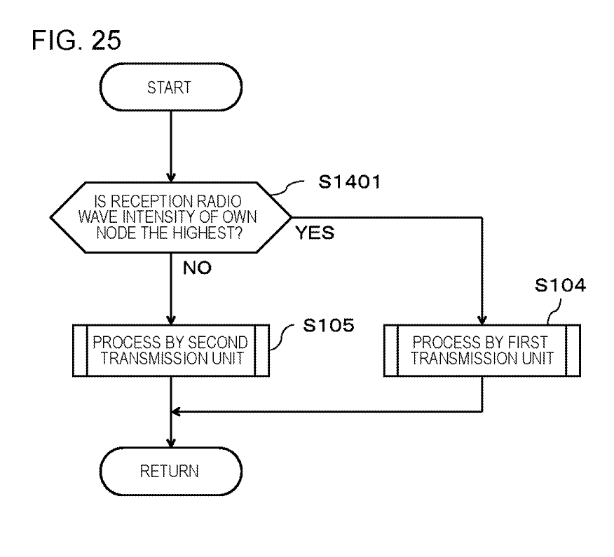

A flow of the process of this exemplary embodiment will be described with reference to FIG. 25. FIG. 25 is a flowchart illustrating a flow for determining which of processes of the first transmission unit 120 and the second transmission unit 130 is to be executed by the communication device 10 in the seventh exemplary embodiment.

In this exemplary embodiment, the determination unit 140 determines whether or not the reception radio wave intensity of the own node is the highest based on the shared reception radio wave intensity of each node (S1401). In a case where the reception radio wave intensity of the own node is the highest (S1401: YES), the determination unit 140 issues a process execution instruction to the first transmission unit 120, and the first transmission unit 120 executes its process (S104). On the other hand, in a case where there is another node having a higher reception radio wave intensity than the own node (S1401: NO), the determination unit 140 issues a process execution instruction to the second transmission unit 130, and the second transmission unit 130 executes its process (S105).

The determination of S1401 described above is executed at a transmission timing for power consumption data, which has been set in each node.

[Operation and Effects of Seventh Exemplary Embodiment]

Thus, in this exemplary embodiment, the communication device 10 having a high reception radio wave intensity from the central node 20 functions as an aggregation device. The high reception radio wave intensity from the central node 20 means that communication conditions are also good for transmission to the central node 20. That is, according to this exemplary embodiment, it is possible for the communication device 10 having good communication conditions with the central node 20 may be made to function as the aggregation device, thus enabling to improve reliability when the power consumption data collected in the communication device 10 is transmitted to the central node 20.

[Modification Example of Seventh Exemplary Embodiment]

According to this modification example, even when the radio wave intensity transmission unit 170 and the radio wave intensity reception unit 172 are not included, it is possible to share the reception radio wave intensity of each communication device 10.

When the second transmission unit 130 of this modification example transmits the power consumption data of the own node in response to the transmission request of another node, the second transmission unit 130 further transmits the reception radio wave intensity acquired by the radio wave intensity acquisition unit 162. The reception radio wave intensity transmitted herein is used to select the communication device 10 to serve as the aggregation device at the next collection timing. At an initial collection timing, for example, an arbitrary one of the communication devices 10 is determined as the aggregation device.

Further, when the first transmission unit 120 of this modification example transmits the power consumption data of the own node to the central node 20, the first transmission unit 120 further transmits the reception radio wave intensity of the own node acquired by the radio wave intensity acquisition unit 162. Further, since the second transmission unit 130 transmits the power consumption data and the reception radio wave intensity in response to the transmission request as described above, when the first transmission unit 120 transmits the transmission request, the reception radio wave intensity of the other node is acquired in addition to the power consumption data of the other node. The first transmission unit 120 of this exemplary embodiment can transmit the power consumption data and the reception radio wave intensity of the other node to the central node 20, in addition to the power consumption data and the reception radio wave intensity of the own node.

As described above, a state of the reception radio wave intensity of each node is collected on the central node 20 side. Accordingly, the central node 20 can select a node suitable for execution of the process by the first transmission unit 120 (that is, anode having high reception radio wave intensity and a good communication environment with the central node) based on the reception radio wave intensity of each node. With respect to the number of nodes executing the process by the first transmission unit 120, one certain node (for example, a node having the highest reception radio wave intensity) may be selected from among the reception radio wave intensities equal to or greater than a predetermined threshold value, or plural nodes of a number equal to or smaller than a predetermined number may be selected. The predetermined number can be determined, for example, according to a total number of communication devices 10 included in the cell of the central node 20. A process execution instruction to be executed by the first transmission unit 120 is transmitted from the central node 20 to the selected node.

The determination unit 140 of the node selected as above determines that the process by the first transmission unit 120 is to be executed in the own node by receiving an instruction transmitted from the central node 20. On the other hand, the determination unit 140 of the unselected node, not having received an instruction from the central node 20, determines that the process by the second transmission unit 130 is to be executed in the own node and waits for a transmission request to be transmitted from another node.

Thus, it is possible to obtain the effects of this exemplary embodiment even according to the present modification example.

### Eighth Exemplary Embodiment

This exemplary embodiment has the same configuration as that of the first exemplary embodiment and the second exemplary embodiment except for the following points. The following description is based on the configuration of the second exemplary embodiment. Further, a case where the condition of “the largest number of nodes that can be communicated with in one hop” is used for the “predetermined condition” in the first exemplary embodiment will be illustrated in the eighth exemplary embodiment.

The determination unit 140 of this exemplary embodiment determines which of the process by the first transmission unit 120 and the process by the second transmission unit 130 is to be executed based on the number of communicable nodes of the own node and those of the other nodes, the number of communicable nodes indicating the number of nodes that can be communicated with in one hop.

[Processing Configuration]

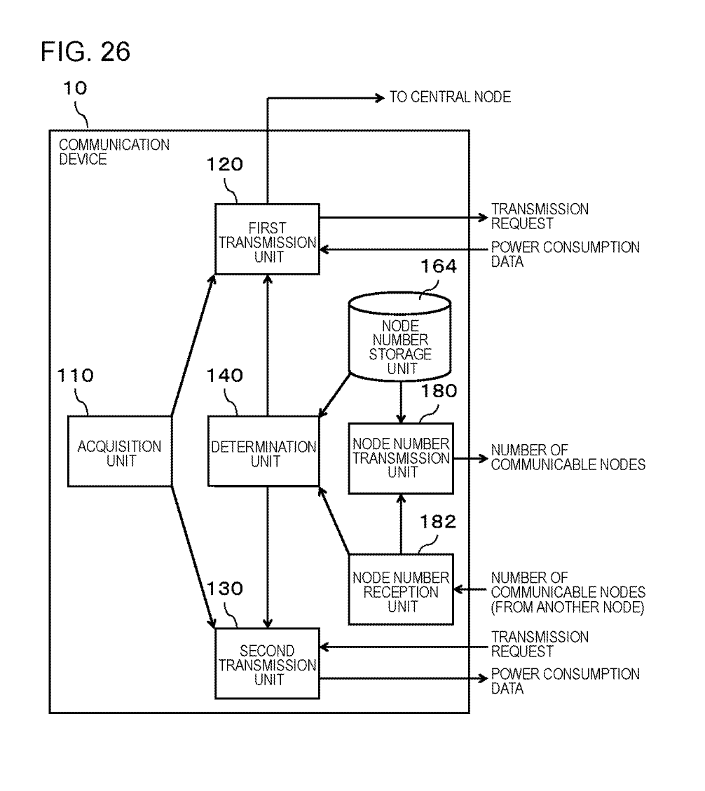

FIG. 26 is a diagram conceptually illustrating an example of a processing configuration of the communication device 10 in the eighth exemplary embodiment. As illustrated in FIG. 26, the communication device 10 of this exemplary embodiment further includes a node number storage unit 164, a node number transmission unit 180, and a node number reception unit 182.

Since the node number storage unit 164 is the same as that described in the fifth exemplary embodiment, description thereof will not be repeated.

The node number transmission unit 180 transmits the node identification information for identifying each node and the number of communicable nodes of the own node to another node. Further, the node number reception unit 182 receives the number of communicable nodes transmitted from the node number transmission unit 180 of another node. Each communication device 10 can acquire the number of communicable nodes of each communication device 10 based on the number of communicable nodes and the node identification information.

Further, each communication device 10 includes the node number transmission unit 180 and the node number reception unit 182, such that in the network built by the plurality of communication devices 10 as illustrated in FIG. 1, the number of communicable nodes of each communication device 10 can be shared.

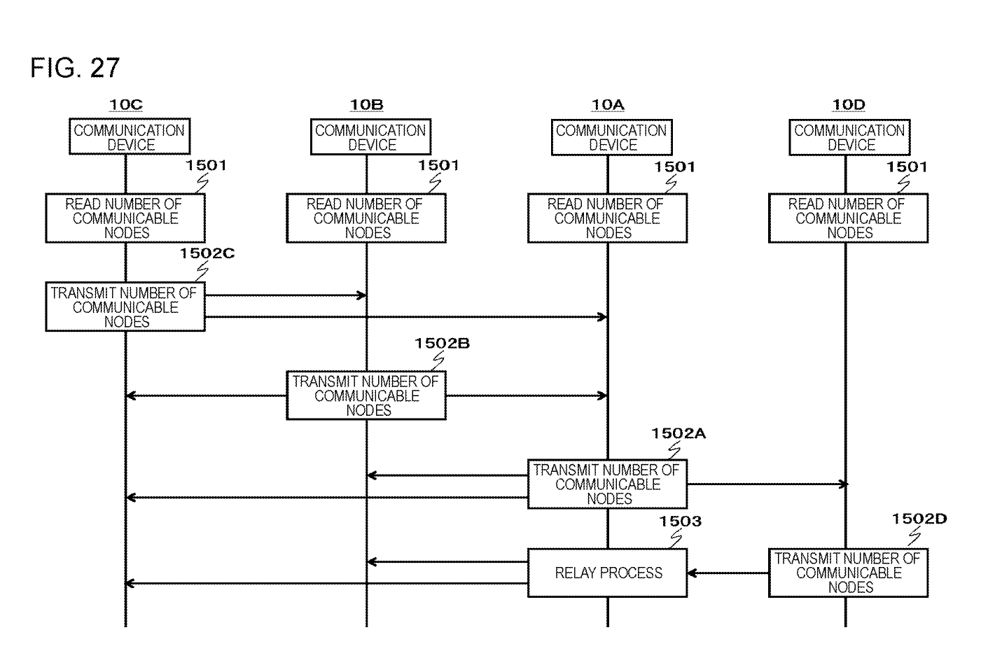

A flow in which the number of communicable nodes of each communication device 10 is shared will be described with reference to FIGS. 23 and 27. FIG. 23 is as described in the seventh exemplary embodiment. FIG. 27 is a sequence diagram illustrating a flow in which a plurality of communication devices 10 share the numbers of communicable nodes.

The flow in which each communication device 10 shares the number of communicable nodes will be described with reference to FIG. 27.

First, each of the communication devices 10A to 10D reads the number of communicable nodes from the respective node number storage unit 164 (S1501). The node number transmission units 180 of the communication devices 10A to 10D attach, to the read number of communicable nodes, for example, the node identification information of the own node and version information allowing to determine old and new of the number of communicable nodes, and transmits the resultant number of nodes to another node via the first communication unit 104.

Here, information including the number of communicable nodes (communicable node number information) that is transmitted from each communication device 10 is transmitted to other communication devices 10 that exist in a communicable range of the first communication unit 104. Specifically, the communicable node number information of the communication device 10A is transmitted to the communication devices 10B, 10C, and 10D (51502A). Further, the communicable node number information of the communication device 10B is transmitted to the communication devices 10A and 10C (S1502B). Further, the communicable node number information of the communication device 10C is transmitted to the communication devices 10A and 10B (S1502C). Further, the communicable node number information of the communication device 10D is transmitted to the communication device 10A (S1502D).

Here, the node number transmission unit 180 of the communication device 10A transmits the communicable node number information from the communication device 10D to the communication devices 10B and 10C (S1303: relay process). In actuality, the node number transmission unit 180 of each communication device 10 transmits, in response to reception of the communicable node number information of the other communication device 10, the received communicable node number information of the other communication device 10, to still another communication device 10. Here, a case may be considered where in each communication device 10, communicable node number information regarding a certain communication device 10 is relayed from a plurality of communication devices 10. In this case, the communication device 10 that has acquired a plurality of pieces of communicable node number information regarding a certain communication device 10 can determine whether or not the plurality of pieces of the relayed communicable node number information match each other based on the version information attached to the communicable node number information. By doing so, the communication device 10 can always acquire the latest communicable node number information (highly accurate communicable node number information).

As described above, it is possible to share the number of communicable nodes in each communication device 10. However, a method of sharing the number of communicable nodes is not limited to the above-described example.

In the configuration of FIG. 26, the determination unit 140 compares the number of communicable nodes of the own node with the number of communicable nodes of another node based on the shared information. In a case where the number of communicable nodes of the own node is the largest as a result of the comparison, the determination unit 140 issues a process execution instruction to the first transmission unit 120. Further, in a case where there is anode having a larger number of communicable nodes than that of the own node as a result of the comparison, the determination unit 140 issues a process execution instruction to the second transmission unit 130.

### Operation Example

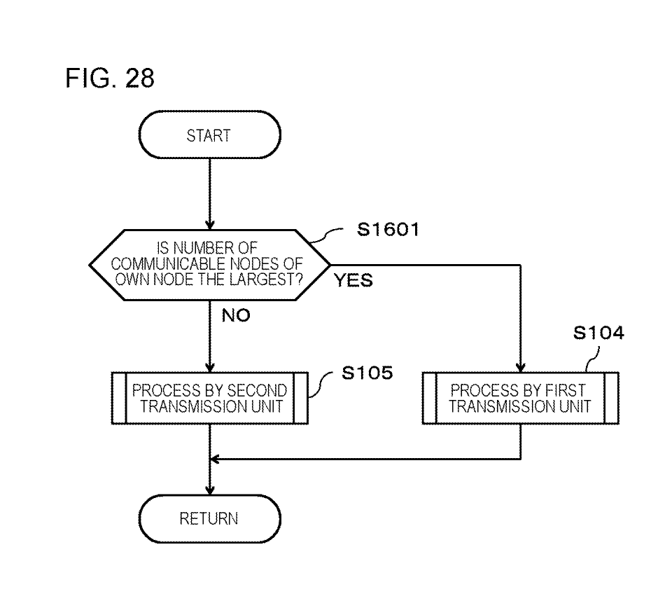

A flow of the process of this exemplary embodiment will be described with reference to FIG. 28. FIG. 28 is a flowchart illustrating a flow for determining which of processes of the first transmission unit 120 and the second transmission unit 130 is to be executed by the communication device 10 in the eighth exemplary embodiment.

In this exemplary embodiment, the determination unit 140 determines whether or not the number of communicable nodes of the own node is the largest based on the shared number of communicable nodes of each node (S1601). In a case where the number of communicable nodes of the own node is the largest (S1601: YES), the determination unit 140 issues a process execution instruction to the first transmission unit 120, and the first transmission unit 120 executes its process (S104). On the other hand, in a case where there is another node having a larger number of communicable nodes than that of the own node (S1601: NO), the determination unit 140 issues a process execution instruction to the second transmission unit 130, and the second transmission unit 130 executes its process (S105).

The determination of S1601 described above is set in each node and executed at a transmission timing for the power consumption data.

[Operation and Effects of Eighth Exemplary Embodiment]

Thus, in this exemplary embodiment, the communication device 10 having a large number of communicable nodes functions as the aggregation device. That is, according to this exemplary embodiment, the communication device 10 capable of transmitting a transmission request to a large number of child nodes in one hop can function as the aggregation device, and an effect can be expected of reducing the time taken to collect power consumption data from another communication device 10.

[Modification Example of Eighth Exemplary Embodiment]

According to this modification example, even when the node number transmission unit 180 and the node number reception unit 182 are not included, the number of communicable nodes each communication device 10 can be shared.

When the second transmission unit 130 of this modification example transmits power consumption data of the own node in response to a transmission request from another node, the second transmission unit 130 further transmits the number of communicable nodes stored in the node number storage unit 164. The number of communicable nodes to be transmitted herein is used to select the communication device 10 to serve as the aggregation device at the next collection timing. At an initial collection timing, for example, an arbitrary communication device 10 is determined as the aggregation device.

Further, when the first transmission unit 120 of this modification example transmits the power consumption data of the own node to the central node 20, the first transmission unit 120 further transmits the number of communicable nodes of the own node stored in the node number storage unit 164. Further, when a transmission request is transmitted from the first transmission unit 120, since the second transmission unit 130 transmits power consumption data and the number of communicable nodes in response to the transmission request as described above, the number of communicable nodes of another node is acquired in addition to the power consumption data of that node. The first transmission unit 120 of this exemplary embodiment can transmit the power consumption data and the number of communicable nodes of the other node to the central node 20, in addition to the power consumption data and the number of communicable nodes of the own node.

As described above, the state of the number of communicable nodes of each node is collected on the central node 20 side. Accordingly, the central node 20 can select a node suitable for execution of the process by the first transmission unit 120 (that is, a node having a large number of nodes that can be communicated with in one hop) based on the number of communicable nodes of each node. With respect to the number of nodes executing the process by the first transmission unit 120, one certain node (for example, a node having the largest number of communicable nodes) may be selected from among nodes having the number of communicable nodes equal to or greater than a predetermined threshold value, or plural nodes of equal to or smaller than a predetermined number may be selected. The predetermined number can be determined, for example, according to a total number of communication devices 10 included in the cell of the central node 20. A process execution instruction to be executed by the first transmission unit 120 is transmitted from the central node 20 to the selected node.

The determination unit 140 of the selected node determines that the process by the first transmission unit 120 is to be executed in the own node by receiving an instruction transmitted from the central node 20. On the other hand, since the determination unit 140 of an unselected node, not having received an instruction from the central node 20, determines that the process by the second transmission unit 130 is to be executed in the own node and waits for a transmission request to be transmitted from another node.

Thus, according to this modification example, it is possible to obtain the effects of this exemplary embodiment.

Although the exemplary embodiments of the present invention have been described with reference to the drawings, these are illustrative examples of the present invention, and various configurations other than the above can be adopted. For example, the example regarding “power consumption data” that is information including a power accumulation value measured in a case where the node is a wattmeter has been shown in each of the above-described exemplary embodiments, but the present invention is not limited to this example. The present invention is also applicable to a case where information acquired or received at each node is information (for example, an accumulation value of the amount of use of gas or water, although not particularly limited) other than the “power consumption data”.

Further, a plurality of steps (processes) have been sequentially described in the plurality of flowcharts used in the above description, but an order of execution of the steps that are executed in each exemplary embodiment is not limited to the described order. In each exemplary embodiment, the order of the illustrated steps can be changed in a range in which no problem in content. Further, in each of the above-described exemplary embodiments, a combination can be performed in a range in which content does not conflict.

Hereinafter, examples of a reference form will be additionally described.

1. A communication device that is a node capable of communication with an external device, the communication device including:
a first transmission unit that transmits power consumption data of the node and power consumption data acquired from another node to the external device;
a second transmission unit that transmits the power consumption data of the node to the other node; and
a determination unit that determines which of a process by the first transmission unit and a process by the second transmission unit is to be executed based on a predetermined condition.
   2. The communication device as described in 1, further including:
a timing management unit that manages a transmission timing to transmit the power consumption data of the node to the external device,
in which the determination unit causes the second transmission unit to execute its process in a case where a power consumption data transmission request is received from the other node during a period from acquisition of the power consumption data of the node to the transmission timing thereof.
   3. The communication device as described in 2,
in which the determination unit causes the first transmission unit to execute its process in a case where reception radio wave intensity of the node is equal to or greater than a predetermined threshold value, the reception radio wave intensity indicating the intensity of radio waves received from the external device.
   4. The communication device as described in 2 or 3,
in which the determination unit causes the first transmission unit to execute its process in a case where the number of nodes that can be communicated with in one hop from the node is equal to or greater than a predetermined threshold value.
   5. The communication device as described in 1,
in which the determination unit determines which of the process by the first transmission unit and the process by the second transmission unit is to be executed based on reception radio wave intensity of the node and reception radio wave intensity of the other node, the reception radio wave intensity indicating intensity of radio waves received from the external device.
   6. The communication device as described in 5, further including:
a radio wave intensity transmission unit that transmits the reception radio wave intensity of the node to another node; and
a radio wave intensity reception unit that receives reception radio wave intensity of the other node from the other node,
in which, as a result of comparing the reception radio wave intensity of the node with that of the other node, the determination unit executes the process by the first transmission unit in a case where the reception radio wave intensity of the node is the highest, and executes the process by the second transmission unit in a case where the reception radio wave intensity of the other node is higher than that of the node.
   7. The communication device as described in 5,
in which the second transmission unit transmits the power consumption data of the node and the reception radio wave intensity of the node in response to a power consumption data transmission request from the other node,
the first transmission unit transmits power consumption data and reception radio wave intensity acquired from the other node in addition to the power consumption data of the node and the reception radio wave intensity of the node to the external device, and
the determination unit receives an instruction from the external device based on the reception radio wave intensity of each node, and determines which of the process by the first transmission unit and the process by the second transmission unit is to be executed in response to the instruction.
   8. The communication device as described in 1,
in which the determination unit determines which of the process by the first transmission unit and the process by the second transmission unit is to be executed based on the number of communicable nodes of the node and the number of communicable nodes of the other node, the number of communicable nodes indicating the number of nodes that can be communicated with in one hop.
   9. The communication device as described in 8, further including:
a node number transmission unit that transmits the number of communicable nodes of the node to the other node; and
a node number reception unit that receives the number of communicable nodes of the other node from the other node,
in which, as a result of comparing the number of communicable nodes of the node with that of the other node, the determination unit executes the process by the first transmission unit in a case where the number of communicable nodes of the node is largest, and executes the process by the second transmission unit in a case where the number of communicable nodes of the other node is larger than the number of communicable nodes of the node.
   10. The communication device as described in 8,
in which the second transmission unit transmits the power consumption data of the node and the number of communicable nodes of the node in response to the power consumption data transmission request from the other node,
the first transmission unit transmits the power consumption data and the number of communicable nodes acquired from the other node to the external device in addition to the power consumption data of the node and the number of communicable nodes of the node, and
the determination unit receives an instruction from the external device based on the number of communicable nodes of each node, and determines which of the process by the first transmission unit and the process by the second transmission unit is to be executed in response to the instruction.
   11. The communication device as described in any one of 1 to 10,
in which the second transmission unit transfers the transmission request from the other node to still another node in response to the transmission request from the other node, and transmits the power consumption data of the node and the power consumption data acquired from the still another node to the other node.
   12. The communication device as described in 11, further including:
a cell information storage unit that stores cell identification information for identifying a cell corresponding to the node,
in which the first transmission unit attaches the cell identification information to a power consumption data transmission request and transmits the request to another node, and
the second transmission unit transmits a response to the transmission request from the other node and transfers the transmission request from the other node, in a case where the cell identification information attached to the power consumption data transmission request from the other node corresponds to the cell identification information of the node.
   13. The communication device as described in 11,
in which the first transmission unit attaches hop number information indicating the number of hops to a power consumption data transmission request and transmits the request to another node, and
the second transmission unit determines the number of hops of the node based on the hop number information attached to the power consumption data transmission request from the other node, and in a case where the determined number of hops of the node is smaller than a predetermined number of hops, the second transmission unit updates the hop number information based on the determined number of hops of the node, attaches the updated hop number information, and transfers the transmission request from the other node.
   14. The communication device as described in any one of 1 to 13,
in which the first transmission unit transmits a power consumption data transmission request to the other node, and transmits power consumption data acquired from the other node to the external device before elapse of a predetermined period of time from transmission of the transmission request.
   15. A communication method executed by a computer that is a node capable of communicating with an external device, the method including:
a first transmission step of transmitting power consumption data of the node and power consumption data acquired from another node to the external device;
a second transmission step of transmitting the power consumption data of the node to the other node; and
a determination step of determining which of a process by the first transmission unit and a process by the second transmission unit is to be executed based on a predetermined condition.
   16. The communication method executed by the computer as described in 15, further including:
managing a transmission timing to transmit the power consumption data of the node to the external device; and
executing the second transmission process in a case where a power consumption data transmission request is received from the other node during a period from acquisition of the power consumption data of the node to the transmission timing thereof.
   17. The communication method executed by the computer as described in 16, further including
executing the first transmission process in a case where reception radio wave intensity of the node is equal to or greater than a predetermined threshold value, the reception radio wave intensity indicating the intensity of radio waves received from the external device.
   18. The communication method executed by the computer as described in 16 or 17, further including
executing the first transmission process in a case where the number of nodes that can be communicated with in one hop from the node is equal to or greater than a predetermined threshold value.
   19. The communication method executed by the computer as described in 15, further including
determining which of the process by the first transmission unit and the process by the second transmission unit is to be executed based on reception radio wave intensity of the node and reception radio wave intensity of the other node, the reception radio wave intensity indicating the intensity of radio waves received from the external device.
   20. The communication method executed by the computer as described in 19, further including:
transmitting the reception radio wave intensity of the node to another node;
receiving reception radio wave intensity of the other node from the other node; and
executing, as a result of comparing the reception radio wave intensity of the node with that of the other node, the process by the first transmission unit in a case where the reception radio wave intensity of the node is the highest and the process by the second transmission unit in a case where the reception radio wave intensity of the other node is higher than that of the node.
   21. The communication method executed by the computer as described in 19, further including:
receiving an instruction from the external device based on the reception radio wave intensity of each node, and determining which of the first transmission process and the second transmission process is to be executed in response to the instruction;
transmitting the power consumption data of the node and the reception radio wave intensity of the node in response to a power consumption data transmission request from the other node in the second process; and
transmitting power consumption data and reception radio wave intensity acquired from the other node in addition to the power consumption data of the node and the reception radio wave intensity of the node to the external device in the first process.
   22. The communication method executed by the computer as described in 15, further including
determining which of the first transmission process and the second transmission process is to be executed based on the number of communicable nodes of the node and the number of communicable nodes of another node, the number of communicable nodes indicating the number of nodes that can be communicated with in one hop.
   23. The communication method executed by the computer as described in 22, further including:
transmitting the number of communicable nodes of the node to the other node;
receiving the number of communicable nodes of the other node from the other node; and
as a result of comparing the number of communicable nodes of the node with that of the other node, executing the process by the first transmission unit in a case where the number of communicable nodes of the node is the largest, and executing the process by the second transmission unit in a case where the number of communicable nodes of the other node is larger than that of the node.
   24. The communication method executed by the computer as described in 22, further including:
receiving an instruction from the external device based on the number of communicable nodes of each node, and determining which of the first transmission process and the second transmission process is to be executed in response to the instruction;
transmitting the power consumption data of the node and the number of communicable nodes of the node in response to the power consumption data transmission request from the other node in the second transmission process; and
transmitting the power consumption data of the node and the number of communicable nodes of the node, and the power consumption data and the number of communicable nodes acquired from the other node to the external device in the first transmission process.
   25. The communication method executed by the computer as described in any one of 15 to 24, further including
transferring, in the second transmission process, the transmission request from the other node to still another node in response to the transmission request from the other node, and transmitting power consumption data of the node and power consumption data acquired from the still another node to the other node.
   26. The communication method executed by the computer as described in 25, further including:
storing cell identification information for identifying a cell corresponding to the node;
attaching the cell identification information to a power consumption data transmission request and transmitting the request to another node in the first transmission process; and
transmitting a response to the transmission request from the other node and transferring the transmission request from the other node in the second transmission process, in a case where the cell identification information attached to the power consumption data transmission request from the other node corresponds to the cell identification information of the node.
   27. The communication method executed by the computer as described in 25, further including:
attaching hop number information indicating the number of hops to a power consumption data transmission request and transmitting the request to another node in the first transmission process;
determining the number of hops of the node based on the hop number information attached to the power consumption data transmission request from the other node in the second transmission process; and
in a case where the determined number of hops of the node is smaller than a predetermined number of hops, updating the hop number information based on the determined number of hops of the node, attaching the updated hop number information, and transferring the transmission request from the other node.
   28. The communication method executed by the computer as described in any one of 15 to 27, further including
transmitting a power consumption data transmission request to the other node, and transmitting power consumption data acquired from the other node to the external device before elapse of a predetermined period of time from transmission of the transmission request in the first transmission process.
   29. A program for causing a computer that is a node capable of communication with an external device to function as:
a first transmission unit that transmits power consumption data of the node and power consumption data acquired from another node to the external device;
a second transmission unit that transmits the power consumption data of the node to the other node; and
a determination unit that determines which of a process by the first transmission unit and a process by the second transmission unit is to be executed based on a predetermined condition.
   30. The program as described in 29, causing the computer to further function as
a timing management unit that manages a transmission timing to transmit the power consumption data of the node to the external device,
in which the determination unit causes the second transmission unit to execute its process in a case where a power consumption data transmission request is received from the other node during a period from acquisition of the power consumption data of the node to the transmission timing thereof.
   31. The program as described in 30,
in which, the determination unit causes the first transmission unit to execute its process in a case where reception radio wave intensity of the node is equal to or greater than a predetermined threshold value, the reception radio wave intensity indicating the intensity of radio waves received from the external device.
   32. The program as described in 30 or 31,
in which the determination unit causes the first transmission unit to execute its process in a case where the number of nodes that can be communicated with in one hop from the node is equal to or greater than a predetermined threshold value.
   33. The program as described in 29,
in which the determination unit determines which of the process by the first transmission unit and the process by the second transmission unit is to be executed based on reception radio wave intensity of the node and that of the other node, the reception radio wave intensity indicating the intensity of radio waves received from the external device.
   34. The program as described in 33, causing the computer to further function as:
a radio wave intensity transmission unit that transmits the reception radio wave intensity of the node to another node; and
a radio wave intensity reception unit that receives reception radio wave intensity of the other node from the other node,
in which, as a result of comparing the reception radio wave intensity of the node with that of the other node, the determination unit executes the process by the first transmission unit in a case where the reception radio wave intensity of the node is the highest, and executes the process by the second transmission unit in a case where the reception radio wave intensity of the other node is higher than that of the node.
   35. The program as described in 33,
in which the second transmission unit transmits the power consumption data of the node and the reception radio wave intensity of the node in response to a power consumption data transmission request from the other node,
the first transmission unit transmits power consumption data and reception radio wave intensity acquired from the other node in addition to the power consumption data of the node and the reception radio wave intensity of the node to the external device, and
the determination unit receives an instruction from the external device based on the reception radio wave intensity of each node, and determines which of the process by the first transmission unit and the process by the second transmission unit is to be executed in response to the instruction.
   36. The program as described in 29,
in which the determination unit determines which of the process by the first transmission unit and the process by the second transmission unit is to be executed based on the number of communicable nodes of the node and the number of communicable nodes of another node, the number of communicable nodes indicating the number of nodes that can be communicated with in one hop.
   37. The program as described in 36, causing the computer to further function as:
a node number transmission unit that transmits the number of communicable nodes of the node to the other node; and
a node number reception unit that receives the number of communicable nodes of the other node from the other node,
in which, as a result of comparing the number of communicable nodes of the node with that of the other node, the determination unit executes the process by the first transmission unit in a case where the number of communicable nodes of the node is the largest, and executes the process by the second transmission unit in a case where the number of communicable nodes of the other node is larger than the number of communicable nodes of the node.
   38. The program as described in 36,
in which the second transmission unit transmits the power consumption data of the node and the number of communicable nodes of the node in response to the power consumption data transmission request from the other node,
the first transmission unit transmits the power consumption data and the number of communicable nodes acquired from the other node to the external device in addition to the power consumption data of the node and the number of communicable nodes of the node, and
the determination unit receives an instruction from the external device based on the number of communicable nodes of each node, and determines which of the process by the first transmission unit and the process by the second transmission unit is to be executed in response to the instruction.
   39. The program as described in any one of 29 to 38,
in which the second transmission unit transfers the transmission request from the other node to still another node in response to the transmission request from the other node, and transmits power consumption data of the node and power consumption data acquired from the still another node to the other node.
   40. The program as described in 39 causing the computer to further function as:
a cell information storage unit that stores cell identification information for identifying a cell corresponding to the node,
in which the first transmission unit attaches the cell identification information to a power consumption data transmission request and transmits the request to another node, and
the second transmission unit transmits a response to the transmission request from the other node and transfers the transmission request from the other node in a case where the cell identification information attached to the power consumption data transmission request from the other node corresponds to the cell identification information of the node.
   41. The program as described in 39,
in which the first transmission unit attaches hop number information indicating the number of hops to a power consumption data transmission request and transmits the request to another node,
the second transmission unit determines the number of hops of the node based on the hop number information attached to the power consumption data transmission request from the other node, and
in a case where the determined number of hops of the node is smaller than a predetermined number of hops, the second transmission unit updates the hop number information based on the determined number of hops of the node, attaches the updated hop number information, and transfers the transmission request from the other node.
   42. The program as described in any one of 29 to 41,
in which the first transmission unit transmits a power consumption data transmission request to the other node, and transmits power consumption data acquired from the other node to the external device before elapse of a predetermined period of time from transmission of the transmission request.

Priority is claimed on Japanese Patent Application No. 2014-213456, filed Oct. 20, 2014, the content of which is incorporated herein by reference.

1. A communication device that is a node capable of communication with an external device, the communication device comprising:
a first transmission unit that transmits power consumption data of the node and power consumption data acquired from another node to the external device;
a second transmission unit that transmits the power consumption data of the node to the other node; and
a determination unit that determines which of a process by the first transmission unit and a process by the second transmission unit is to be executed based on a predetermined condition.

2. The communication device according to claim 1, further comprising
a timing management unit that manages a transmission timing to transmit the power consumption data of the node to the external device,
wherein the determination unit causes the second transmission unit to execute its process in a case where a power consumption data transmission request is received from the other node during a period from acquisition of the power consumption data of the node to the transmission timing thereof.

3. The communication device according to claim 2,
wherein the determination unit causes the first transmission unit to execute its process in a case where reception radio wave intensity of the node is equal to or greater than a predetermined threshold value, the reception radio wave intensity indicating the intensity of radio waves received from the external device.

4. The communication device according to claim 2,
wherein the determination unit causes the first transmission unit to execute its process in a case where the number of nodes that can be communicated with in one hop from the node is equal to or greater than a predetermined threshold value.

5. The communication device according to claim 1,
wherein the determination unit determines which of the process by the first transmission unit and the process by the second transmission unit is to be executed based on reception radio wave intensity of the node and that of the other node, the reception radio wave intensity indicating the intensity of radio waves received from the external device.

6. The communication device according to claim 5, further comprising:
a radio wave intensity transmission unit that transmits reception radio wave intensity of the node to another node; and
a radio wave intensity reception unit that receives reception radio wave intensity of the other node from the other node,
wherein, as a result of comparing the reception radio wave intensity of the node with that of the other node, the determination unit executes the process by the first transmission unit in a case where the reception radio wave intensity of the node is the highest, and executes the process by the second transmission unit in a case where the reception radio wave intensity of the other node is higher than that of the node.

7. The communication device according to claim 5,
wherein the second transmission unit transmits the power consumption data of the node and the reception radio wave intensity of the node to the other node in response to a power consumption data transmission request from the other node,
the first transmission unit transmits power consumption data and reception radio wave intensity acquired from the other node in addition to the power consumption data of the node and the reception radio wave intensity of the node to the external device, and
the determination unit receives an instruction from the external device based on the reception radio wave intensity of each node, and determines which of the process by the first transmission unit and the process by the second transmission unit is to be executed in response to the instruction.

8. The communication device according to claim 1,
wherein the determination unit determines which of the process by the first transmission unit and the process by the second transmission unit is to be executed based on the number of communicable nodes of the node and the number of communicable nodes of the other node, the number of communicable nodes indicating the number of nodes that can be communicated with in one hop.

9. The communication device according to claim 8, further comprising:
a node number transmission unit that transmits, to the other node, the number of communicable nodes of the node; and
a node number reception unit that receives, from the other node, the number of communicable nodes of the other node,
wherein, as a result of comparing the number of communicable nodes of the node with that of the other node, the determination unit executes the process by the first transmission unit in a case where the number of communicable nodes of the node is the largest and executes the process by the second transmission unit in a case where the number of communicable nodes of the other node is larger than that of the node.

10. The communication device according to claim 8,
wherein the second transmission unit transmits the power consumption data of the node and the number of communicable nodes of the node in response to the power consumption data transmission request from the other node,
the first transmission unit transmits the power consumption data and the number of communicable nodes acquired from the other node in addition to the power consumption data of the node and the number of communicable nodes of the node to the external device, and
the determination unit receives an instruction from the external device based on the number of communicable nodes of each node, and determines which of the process by the first transmission unit and the process by the second transmission unit is to be executed in response to the instruction.

11. The communication device according to claim 1,
wherein the second transmission unit transfers the transmission request from the other node to still another node in response to the transmission request from the other node, and transmits power consumption data of the node and power consumption data acquired from the still another node to the other node.

12. The communication device according to claim 11, further comprising
a cell information storage unit that stores cell identification information for identifying a cell corresponding to the node,
wherein the first transmission unit attaches the cell identification information to a power consumption data transmission request and transmits the request to another node, and
the second transmission unit transmits a response to the transmission request from the other node and transfers the transmission request from the other node in a case where the cell identification information attached to the power consumption data transmission request from the other node corresponds to the cell identification information of the node.

13. The communication device according to claim 11,
wherein the first transmission unit attaches hop number information indicating the number of hops to a power consumption data transmission request and transmits the request to another node, and
the second transmission unit determines the number of hops of the node based on the hop number information attached to the power consumption data transmission request from the other node, and in a case where the determined number of hops of the node is smaller than a predetermined number of hops, updates the hop number information based on the determined number of hops of the node, attaches the updated hop number information to the transmission request from the other node, and transfers the request.

14. The communication device according to claim 1,
wherein the first transmission unit transmits a power consumption data transmission request to the other node, and transmits power consumption data acquired from the other node to the external device before elapse of a predetermined period of time from the transmission of the transmission request.

15. A communication method executed by a computer that is a node capable of communication with an exterior device, the method comprising:
a first transmission step of transmitting power consumption data of the node and power consumption data acquired from another node to the external device;
a second transmission step of transmitting the power consumption data of the node to the other node; and
a determination step of determining which of a process by the first transmission unit and a process by the second transmission unit is to be executed based on a predetermined condition.

16. A non-transitory computer readable medium storing a program for causing a computer that is a node capable of communication with an external device to function as:
a first transmission unit that transmits power consumption data of the node and power consumption data acquired from another node to the external device;
a second transmission unit that transmits the power consumption data of the node to the other node; and
a determination unit that determines which of a process by the first transmission unit and a process by the second transmission unit is to be executed based on a predetermined condition.
